(19) United States
(12) Patent Application Publication
(10) Pub. No.: US 2019/0220765 A1
(43) Pub. Date: Jul. 18, 2019

(54) Probabilistic Modeling System and Method

(71) Applicant: Gamalon, Inc., Cambridge, MA (US)

(72) Inventors: Benjamin W. Vigoda, Winchester, MA (US); Glynnis Kearney, Medford, MA (US); Pawel Jerzy Zimoch, Cambridge, MA (US); Matthew C. Barr, Malden, MA (US); Martin Blood Zwirner Forsythe, Cambridge, MA (US)

(21) Appl. No.: 16/247,282

(22) Filed: Jan. 14, 2019

Related U.S. Application Data
(60) Provisional application No. 62/616,784, filed on Jan. 12, 2018.
(60) Provisional application No. 62/617,790, filed on Jan. 16, 2018.

(51) Int. Cl. G06N 7/00; G06N 5/04; G06N 20/00

(52) U.S. Cl. CPC G06N 7/005; G06N 20/00; G06N 5/048

(57) ABSTRACT

A computer-implemented method, computer program product and computing system for identifying a specific uncertainty in a probabilistic model; providing a user with one or more initial questions concerning the specific uncertainty; and receiving a response from the user concerning the one or more initial questions.

### RELATED APPLICATION(S)

This application claims the benefit of the following: U.S. Provisional Application Nos.: 62/616,784, filed on 12 Jan. 2018 and 62/617,790, filed on 16 Jan. 2018, their entire contents of which are herein incorporated by reference.

### TECHNICAL FIELD

This disclosure relates to probabilistic models and, more particularly, to the automated generation of probabilistic models.

### BACKGROUND

Businesses may receive and need to process content that comes in various formats (e.g., fully-structured content, semi-structured content, and unstructured content). The processing of such content may occur via the use of probabilistic models, wherein these probabilistic models may be generated based upon the content to be processed.

As is known, the world of traditional programming was revolutionized through the use of object-oriented programming, wherein portions of code are configured as objects (that effectuate simpler tasks/procedures) that are then compiled/linked together to form a more complex system that effectuates more complex tasks/procedures.

Unfortunately and when designing probabilistic models, these models are generated organically regardless of whether or not portions of the model are common in nature.

### SUMMARY OF DISCLOSURE

In one implementation, a computer-implemented method is executed on a computing device and includes: identifying a specific uncertainty in a probabilistic model; providing a user with one or more initial questions concerning the specific uncertainty; and receiving a response from the user concerning the one or more initial questions.

One or more of the following features may be included. The response received from the user may define a value for the specific uncertainty. The response received from the user may reduce the uncertainty level of the specific uncertainty. The response received from the user may include rule-based information that may be used with a future uncertainty. An action may be taken based, at least in part, upon the response received from the user. The action taken may include clarifying the specific uncertainty. The action taken may include providing the user with one or more additional questions concerning the specific uncertainty. The one or more initial questions concerning the specific uncertainty may be formed using previously-learned knowledge.

In another implementation, a computer program product resides on a computer readable medium and has a plurality of instructions stored on it. When executed by a processor, the instructions cause the processor to perform operations including identifying a specific uncertainty in a probabilistic model; providing a user with one or more initial questions concerning the specific uncertainty; and receiving a response from the user concerning the one or more initial questions.

One or more of the following features may be included. The response received from the user may define a value for the specific uncertainty. The response received from the user may reduce the uncertainty level of the specific uncertainty. The response received from the user may include rule-based information that may be used with a future uncertainty. An action may be taken based, at least in part, upon the response received from the user. The action taken may include clarifying the specific uncertainty. The action taken may include providing the user with one or more additional questions concerning the specific uncertainty. The one or more initial questions concerning the specific uncertainty may be formed using previously-learned knowledge.

In another implementation, a computing system includes a processor and memory is configured to perform operations including identifying a specific uncertainty in a probabilistic model; providing a user with one or more initial questions concerning the specific uncertainty; and receiving a response from the user concerning the one or more initial questions.

One or more of the following features may be included. The response received from the user may define a value for the specific uncertainty. The response received from the user may reduce the uncertainty level of the specific uncertainty. The response received from the user may include rule-based information that may be used with a future uncertainty. An action may be taken based, at least in part, upon the response received from the user. The action taken may include clarifying the specific uncertainty. The action taken may include providing the user with one or more additional questions concerning the specific uncertainty. The one or more initial questions concerning the specific uncertainty may be formed using previously-learned knowledge.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a probabilistic modeling process according to an embodiment of the present disclosure;

FIG. 2 is a flowchart of an implementation of the probabilistic modeling process of FIG. 1 according to an embodiment of the present disclosure;

FIG. 3 is a diagrammatic view of a probabilistic model rendered by the probabilistic modeling process of FIG. 1 according to an embodiment of the present disclosure;

FIG. 4A is diagrammatic view of a pipelining process according to an embodiment of the present disclosure;

FIG. 4B is diagrammatic view of a boosting process according to an embodiment of the present disclosure;

FIG. 4C is diagrammatic view of a transfer learning process according to an embodiment of the present disclosure;

FIG. 4D is diagrammatic view of a Bayesian synthesis process according to an embodiment of the present disclosure;

FIG. 5 is a flowchart of another implementation of the probabilistic modeling process of FIG. 1 according to an embodiment of the present disclosure;

FIG. 6 is a flowchart of another implementation of the probabilistic modeling process of FIG. 1 according to an embodiment of the present disclosure;

FIG. 7 is a flowchart of another implementation of the probabilistic modeling process of FIG. 1 according to an embodiment of the present disclosure;

FIG. 8 is a flowchart of another implementation of the probabilistic modeling process of FIG. 1 according to an embodiment of the present disclosure;

FIG. 9 is a flowchart of another implementation of the probabilistic modeling process of FIG. 1 according to an embodiment of the present disclosure;

FIG. 10 is a flowchart of another implementation of the probabilistic modeling process of FIG. 1 according to an embodiment of the present disclosure;

FIG. 11 is a flowchart of another implementation of the probabilistic modeling process of FIG. 1 according to an embodiment of the present disclosure;

FIG. 12 is a flowchart of another implementation of the probabilistic modeling process of FIG. 1 according to an embodiment of the present disclosure;

FIG. 13 is a flowchart of another implementation of the probabilistic modeling process of FIG. 1 according to an embodiment of the present disclosure; and

FIG. 14 is a flowchart of another implementation of the probabilistic modeling process of FIG. 1 according to an embodiment of the present disclosure.

Like reference symbols in the various drawings indicate like elements.

### DETAILED DESCRIPTION OF THE PREFERRED EMBODIMENTS

System Overview

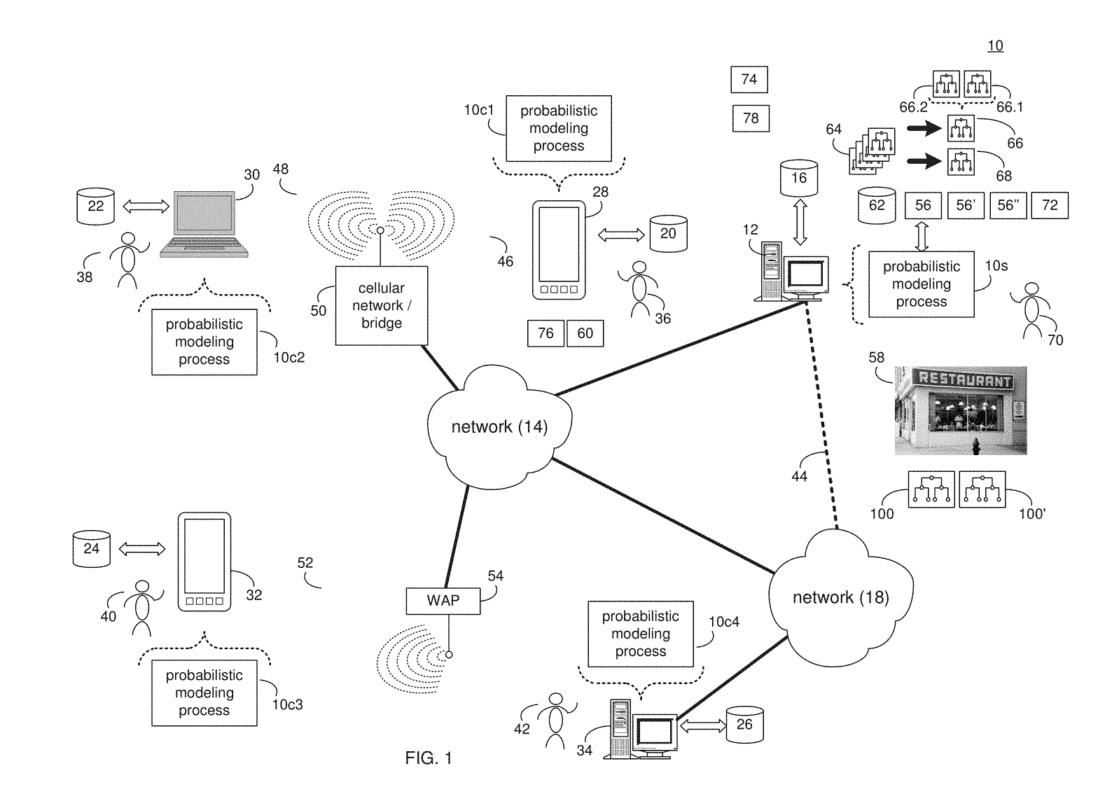

Referring to FIG. 1, there is shown probabilistic modeling process 10. Probabilistic modeling process 10 may be implemented as a server-side process, a client-side process, or a hybrid server-side/client-side process. For example, probabilistic modeling process 10 may be implemented as a purely server-side process via probabilistic modeling process 10s. Alternatively, probabilistic modeling process 10 may be implemented as a purely client-side process via one or more of probabilistic modeling process 10c1, probabilistic modeling process 10c2, probabilistic modeling process 10c3, and probabilistic modeling process 10c4. Alternatively still, probabilistic modeling process 10 may be implemented as a hybrid server-side/client-side process via probabilistic modeling process 10s in combination with one or more of probabilistic modeling process 10c1, probabilistic modeling process 10c2, probabilistic modeling process 10c3, and probabilistic modeling process 10c4. Accordingly, probabilistic modeling process 10 as used in this disclosure may include any combination of probabilistic modeling process 10s, probabilistic modeling process 10c1, probabilistic modeling process 10c2, probabilistic modeling process, and probabilistic modeling process 10c4.

Probabilistic modeling process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of probabilistic modeling process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of probabilistic modeling processes 10c1, 10c2, 10c3, 10c4 may include but are not limited to a client application, a web browser, a game console user interface, or a specialized application (e.g., an application running on e.g., the Android™ platform or the iOS™ platform). The instruction sets and subroutines of probabilistic modeling processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access probabilistic modeling process 10 directly through network 14 or through secondary network 18. Further, probabilistic modeling process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Probabilistic Modeling Overview:

Assume for illustrative purposes that probabilistic modeling process 10 may be configured to process content (e.g., content 56), wherein examples of content 56 may include but are not limited to unstructured content and structured content.

As is known in the art, structured content may be content that is separated into independent portions (e.g., fields, columns, features) and, therefore, may have a pre-defined data model and/or is organized in a pre-defined manner. For example, if the structured content concerns an employee list: a first field, column or feature may define the first name of the employee; a second field, column or feature may define the last name of the employee; a third field, column or feature may define the home address of the employee; and a fourth field, column or feature may define the hire date of the employee.

Further and as is known in the art, unstructured content may be content that is not separated into independent portions (e.g., fields, columns, features) and, therefore, may not have a pre-defined data model and/or is not organized in a pre-defined manner. For example, if the unstructured content concerns the same employee list: the first name of the employee, the last name of the employee, the home address of the employee, and the hire date of the employee may all be combined into one field, column or feature.

For the following example, assume that content 56 is unstructured content, an example of which may include but is not limited to unstructured user feedback received by a company (e.g., text-based feedback such as text-messages, social media posts, and email messages; and transcribed voice-based feedback such as transcribed voice mail, and transcribed voice messages).

When processing content 56, probabilistic modeling process 10 may use probabilistic modeling to accomplish such processing, wherein examples of such probabilistic modeling may include but are not limited to discriminative modeling, generative modeling, or combinations thereof.

As is known in the art, probabilistic modeling may be used within modern artificial intelligence systems (e.g., probabilistic modeling process 10), in that these probabilistic models may provide artificial intelligence systems with the tools required to autonomously analyze vast quantities of data (e.g., content 56).

Examples of the tasks for which probabilistic modeling may be utilized may include but are not limited to:
predicting media (music, movies, books) that a user may like or enjoy based upon media that the user has liked or enjoyed in the past;
transcribing words spoken by a user into editable text;
grouping genes into gene clusters;
identifying recurring patterns within vast data sets;
filtering email that is believed to be spam from a user's inbox;
generating clean (i.e., non-noisy) data from a noisy data set;
analyzing (voice-based or text-based) customer feedback; and
diagnosing various medical conditions and diseases.

For each of the above-described applications of probabilistic modeling, an initial probabilistic model may be defined, wherein this initial probabilistic model may be subsequently (e.g., iteratively or continuously) modified and revised, thus allowing the probabilistic models and the artificial intelligence systems (e.g., probabilistic modeling process 10) to “learn” so that future probabilistic models may be more precise and may explain more complex data sets.

Accordingly, probabilistic modeling process 10 may define an initial probabilistic model for accomplishing a defined task (e.g., the analyzing of content 56). For example, assume that this defined task is analyzing customer feedback (e.g., content 56) that is received from customers of e.g., restaurant 58 via an automated feedback phone line. For this example, assume that content 56 is initially voice-based content that is processed via e.g., a speech-to-text process that results in unstructured text-based customer feedback (e.g., content 56).

With respect to probabilistic modeling process 10, a probabilistic model may be utilized to go from initial observations about content 56 (e.g., as represented by the initial branches of a probabilistic model) to conclusions about content 56 (e.g., as represented by the leaves of a probabilistic model).

As used in this disclosure, the term “branch” may refer to the existence (or non-existence) of a component (e.g., a sub-model) of (or included within) a model. Examples of such a branch may include but are not limited to: an execution branch of a probabilistic program or other generative model, a part (or parts) of a probabilistic graphical model, and/or a component neural network that may (or may not) have been previously trained.

While the following discussion provides a detailed example of a probabilistic model, this is for illustrative purposes only and is not intended to be a limitation of this disclosure, as other configurations are possible and are considered to be within the scope of this disclosure. For example, the following discussion may concern any type of model (e.g., be it probabilistic or other) and, therefore, the below-described probabilistic model is merely intended to be one illustrative example of a type of model and is not intended to limit this disclosure to probabilistic models.

Additionally, while the following discussion concerns word-based routing of messages through a probabilistic model, this is for illustrative purposes only and is not intended to be a limitation of this disclosure, as other configurations are possible and are considered to be within the scope of this disclosure. Examples of other types of information that may be used to route messages through a probabilistic model may include: the order of the words within a message; and the punctuation interspersed throughout the message.

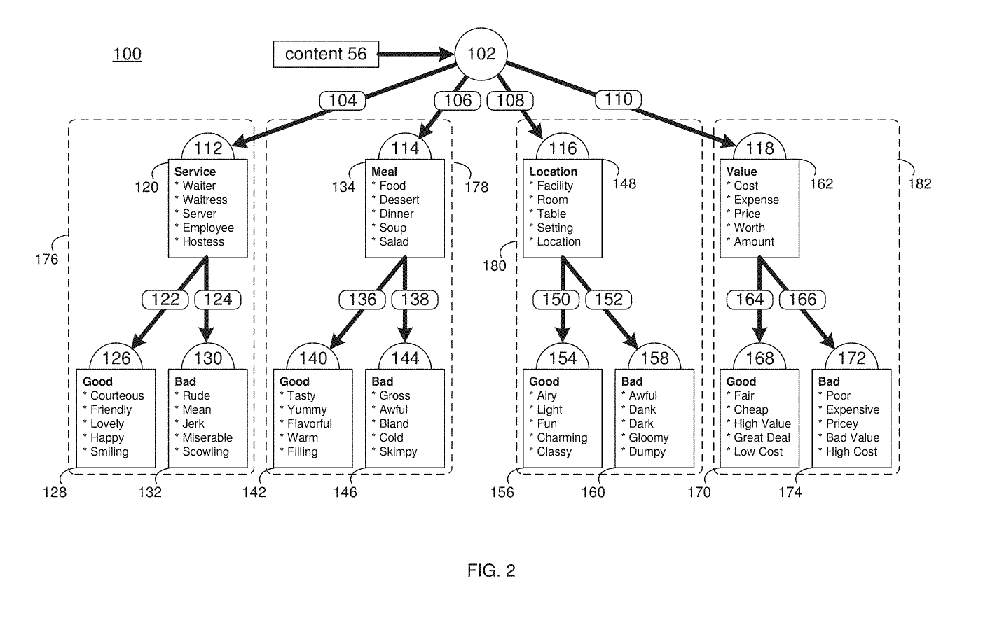

For example and referring also to FIG. 2, there is shown one simplified example of a probabilistic model (e.g., probabilistic model 100) that may be utilized to analyze content 56 (e.g. unstructured text-based customer feedback) concerning restaurant 58. The manner in which probabilistic model 100 may be automatically-generated by probabilistic modeling process 10 will be discussed below in detail. In this particular example, probabilistic model 100 may receive content 56 (e.g. unstructured text-based customer feedback) at branching node 102 for processing. Assume that probabilistic model 100 includes four branches off of branching node 102, namely: service branch 104; meal branch 106; location branch 108; and value branch 110 that respectively lead to service node 112, meal node 114, location node 116, and value node 118.

As stated above, service branch 104 may lead to service node 112, which may be configured to process the portion of content 56 (e.g. unstructured text-based customer feedback) that concerns (in whole or in part) feedback concerning the customer service of restaurant 58. For example, service node 112 may define service word list 120 that may include e.g., the word service, as well as synonyms of (and words related to) the word service (e.g., waiter, waitress, server, employee, and hostess). Accordingly and in the event that a portion of content 56 (e.g., a text-based customer feedback message) includes the word service, waiter, waitress, server, employee and/or hostess, that portion of content 56 may be considered to be text-based customer feedback concerning the service received at restaurant 58 and (therefore) may be routed to service node 112 of probabilistic model 100 for further processing. Assume for this illustrative example that probabilistic model 100 includes two branches off of service node 112, namely: good service branch 122 and bad service branch 124.

Good service branch 122 may lead to good service node 126, which may be configured to process the portion of content 56 (e.g. unstructured text-based customer feedback) that concerns (in whole or in part) good feedback concerning the customer service of restaurant 58. For example, good service node 126 may define good service word list 128 that may include e.g., the word good, as well as synonyms of (and words related to) the word good (e.g., courteous, friendly, lovely, happy, and smiling). Accordingly and in the event that a portion of content 56 (e.g., a text-based customer feedback message) that was routed to service node 112 includes the word good, courteous, friendly, lovely, happy, and/or smiling, that portion of content 56 may be considered to be text-based customer feedback indicative of good service received at restaurant 58 (and, therefore, may be routed to good service node 126).

Bad service branch 124 may lead to bad service node 130, which may be configured to process the portion of content 56 (e.g. unstructured text-based customer feedback) that concerns (in whole or in part) bad feedback concerning the customer service of restaurant 58. For example, bad service node 130 may define bad service word list 132 that may include e.g., the word bad, as well as synonyms of (and words related to) the word bad (e.g., rude, mean, jerk, miserable, and scowling). Accordingly and in the event that a portion of content 56 (e.g., a text-based customer feedback message) that was routed to service node 112 includes the word bad, rude, mean, jerk, miserable, and/or scowling, that portion of content 56 may be considered to be text-based customer feedback indicative of bad service received at restaurant 58 (and, therefore, may be routed to bad service node 130).

As stated above, meal branch 106 may lead to meal node 114, which may be configured to process the portion of content 56 (e.g. unstructured text-based customer feedback) that concerns (in whole or in part) feedback concerning the meal served at restaurant 58. For example, meal node 114 may define meal word list 134 that may include e.g., words indicative of the meal received at restaurant 58. Accordingly and in the event that a portion of content 56 (e.g., a text-based customer feedback message) includes any of the words defined within meal word list 134, that portion of content 56 may be considered to be text-based customer feedback concerning the meal received at restaurant 58 and (therefore) may be routed to meal node 114 of probabilistic model 100 for further processing. Assume for this illustrative example that probabilistic model 100 includes two branches off of meal node 114, namely: good meal branch 136 and bad meal branch 138.

Good meal branch 136 may lead to good meal node 140, which may be configured to process the portion of content 56 (e.g. unstructured text-based customer feedback) that concerns (in whole or in part) good feedback concerning the meal received at restaurant 58. For example, good meal node 140 may define good meal word list 142 that may include words indicative of receiving a good meal at restaurant 58. Accordingly and in the event that a portion of content 56 (e.g., a text-based customer feedback message) that was routed to meal node 114 includes any of the words defined within good meal word list 142, that portion of content 56 may be considered to be text-based customer feedback indicative of a good meal being received at restaurant 58 (and, therefore, may be routed to good meal node 140).

Bad meal branch 138 may lead to bad meal node 144, which may be configured to process the portion of content 56 (e.g. unstructured text-based customer feedback) that concerns (in whole or in part) bad feedback concerning the meal received at restaurant 58. For example, bad meal node 144 may define bad meal word list 146 that may include words indicative of receiving a bad meal at restaurant 58. Accordingly and in the event that a portion of content 56 (e.g., a text-based customer feedback message) that was routed to meal node 114 includes any of the words defined within bad meal word list 146, that portion of content 56 may be considered to be text-based customer feedback indicative of a bad meal being received at restaurant 58 (and, therefore, may be routed to bad meal node 144).

As stated above, location branch 108 may lead to location node 116, which may be configured to process the portion of content 56 (e.g. unstructured text-based customer feedback) that concerns (in whole or in part) feedback concerning the location of restaurant 58. For example, location node 116 may define location word list 148 that may include e.g., words indicative of the location of restaurant 58. Accordingly and in the event that a portion of content 56 (e.g., a text-based customer feedback message) includes any of the words defined within location word list 148, that portion of content 56 may be considered to be text-based customer feedback concerning the location of restaurant 58 and (therefore) may be routed to location node 116 of probabilistic model 100 for further processing. Assume for this illustrative example that probabilistic model 100 includes two branches off of location node 116, namely: good location branch 150 and bad location branch 152.

Good location branch 150 may lead to good location node 154, which may be configured to process the portion of content 56 (e.g. unstructured text-based customer feedback) that concerns (in whole or in part) good feedback concerning the location of restaurant 58. For example, good location node 154 may define good location word list 154 that may include words indicative of restaurant 58 being in a good location. Accordingly and in the event that a portion of content 56 (e.g., a text-based customer feedback message) that was routed to location node 116 includes any of the words defined within good location word list 156, that portion of content 56 may be considered to be text-based customer feedback indicative of restaurant 58 being in a good location (and, therefore, may be routed to good location node 154).

Bad location branch 152 may lead to bad location node 158, which may be configured to process the portion of content 56 (e.g. unstructured text-based customer feedback) that concerns (in whole or in part) bad feedback concerning the location of restaurant 58. For example, bad location node 158 may define bad location word list 160 that may include words indicative of restaurant 58 being in a bad location. Accordingly and in the event that a portion of content 56 (e.g., a text-based customer feedback message) that was routed to location node 116 includes any of the words defined within bad location word list 160, that portion of content 56 may be considered to be text-based customer feedback indicative of restaurant 58 being in a bad location (and, therefore, may be routed to bad location node 158).

As stated above, value branch 110 may lead to value node 118, which may be configured to process the portion of content 56 (e.g. unstructured text-based customer feedback) that concerns (in whole or in part) feedback concerning the value received at restaurant 58. For example, value node 118 may define value word list 162 that may include e.g., words indicative of the value received at restaurant 58. Accordingly and in the event that a portion of content 56 (e.g., a text-based customer feedback message) includes any of the words defined within value word list 162, that portion of content 56 may be considered to be text-based customer feedback concerning the value received at restaurant 58 and (therefore) may be routed to value node 118 of probabilistic model 100 for further processing. Assume for this illustrative example that probabilistic model 100 includes two branches off of value node 118, namely: good value branch 164 and bad value branch 166.

Good value branch 164 may lead to good value node 168, which may be configured to process the portion of content 56 (e.g. unstructured text-based customer feedback) that concerns (in whole or in part) good value being received at restaurant 58. For example, good value node 168 may define good value word list 170 that may include words indicative of receiving good value at restaurant 58. Accordingly and in the event that a portion of content 56 (e.g., a text-based customer feedback message) that was routed to value node 118 includes any of the words defined within good value word list 170, that portion of content 56 may be considered to be text-based customer feedback indicative of good value being received at restaurant 58 (and, therefore, may be routed to good value node 168).

Bad value branch 166 may lead to bad value node 172, which may be configured to process the portion of content 56 (e.g. unstructured text-based customer feedback) that concerns (in whole or in part) bad value being received at restaurant 58. For example, bad value node 172 may define bad value word list 174 that may include words indicative of receiving bad value at restaurant 58. Accordingly and in the event that a portion of content 56 (e.g., a text-based customer feedback message) that was routed to value node 118 includes any of the words defined within bad value word list 174, that portion of content 56 may be considered to be text-based customer feedback indicative of bad value being received at restaurant 58 (and, therefore, may be routed to bad value node 172).

Once it is established that good or bad customer feedback was received concerning restaurant 58 (i.e., with respect to the service, the meal, the location or the value), representatives and/or agents of restaurant 58 may address the provider of such good or bad feedback via e.g., social media postings, text-messages and/or personal contact.

Assume for illustrative purposes that a user (e.g., user 36, 38, 40, 42) of the above-stated probabilistic modeling process 10 provides feedback to restaurant 58 in the form of speech provided to an automated feedback phone line. Further assume for this example that user 36 uses data-enabled, cellular telephone 28 to provide feedback 60 (e.g., a portion of content 56) to the automated feedback phone line. Upon receiving feedback 60 for analysis, this user content (e.g., feedback 60) may be preprocessed (via e.g., a machine process or a third-party). Examples of such preprocessing may include but are not limited to: the correction of spelling errors (e.g., to correct any spelling errors within text-based feedback and to correct any transcription errors within voice-based feedback), the inclusion of additional synonyms, and the removal of irrelevant comments. Accordingly and for this example, such user content (e.g., feedback 60) may be the unprocessed feedback or may be the preprocessed feedback, wherein the author of this feedback may be the user, the third-party, or a collaboration of both. Continuing with the above-stated example, probabilistic modeling process 10 may identify any pertinent content that is included within feedback 60.

For illustrative purposes, assume that user 36 was not happy with their experience at restaurant 58 and that feedback 60 provided by user 36 was “my waiter was rude and the weather was rainy”. Accordingly and for this example, probabilistic modeling process 10 may identify the pertinent content (included within feedback 60) as the phrase “my waiter was rude” and may ignore/remove the irrelevant content “the weather was rainy”. As (in this example) feedback 60 includes the word “waiter”, probabilistic modeling process 10 may rout feedback 60 to service node 112 via service branch 104. Further, as feedback 60 also includes the word “rude”, probabilistic modeling process 10 may rout feedback 60 to bad service node 130 via bad service branch 124 and may consider feedback 60 to be text-based customer feedback indicative of bad service being received at restaurant 58.

For further illustrative purposes, assume that user 36 was happy with their experience at restaurant 58 and that feedback 60 provided by user 36 was “my dinner was yummy but my cab got stuck in traffic”. Accordingly and for this example, probabilistic modeling process 10 may identify the pertinent content (included within feedback 60) as the phrase “my dinner was yummy” and may ignore/remove the irrelevant content “my cab got stuck in traffic”. As (in this example) feedback 60 includes the word “dinner”, probabilistic modeling process 10 may rout feedback 60 to meal node 114 via meal branch 106. Further, as feedback 60 also includes the word “yummy”, probabilistic modeling process 10 may rout feedback 60 to good meal node 140 via good meal branch 136 and may consider feedback 60 to be text-based customer feedback indicative of a good meal being received at restaurant 58.

Thus far, the examples of customer feedback 60 have concerned only one facet of restaurant 58, wherein: the first example of feedback 60 concerned bad feedback with respect to the service received at restaurant 58, while the second example of feedback 60 concerned good feedback with respect to the meal received at restaurant 58. Accordingly, both examples of feedback 60 have been routed to only one end node. However, it is understood that a single piece of feedback may concern multiple facets of restaurant 58. Accordingly, it is foreseeable that a single piece of feedback may need to be routed to a plurality of end nodes.

For example and for further illustrative purposes, assume that user 36 had mixed feeling concerning their experience at restaurant 58 and that feedback 60 provided by user 36 was “my waiter was rude and the weather was rainy but my dinner was yummy even though my cab got stuck in traffic”. Accordingly and for this example, probabilistic modeling process 10 may identify the pertinent content (included within feedback 60) as the phrases “my waiter was rude” and “my dinner was yummy” and may ignore/remove the irrelevant content “the weather was rainy” and “my cab got stuck in traffic”. As (in this example) feedback 60 includes the word “waiter”, probabilistic modeling process 10 may rout feedback 60 (or a portion thereof) to service node 112 via service branch 104. Further, as feedback 60 also includes the word “rude”, probabilistic modeling process 10 may rout feedback 60 (or a portion thereof) to bad service node 130 via bad service branch 124 and may consider this portion of feedback 60 to be text-based customer feedback indicative of bad service being received at restaurant 58. Further, since feedback 60 includes the word “dinner”, probabilistic modeling process 10 may rout feedback 60 (or a portion thereof) to meal node 114 via meal branch 106. Further, as feedback 60 also includes the word “yummy”, probabilistic modeling process 10 may rout feedback 60 (or a portion thereof) to good meal node 140 via good meal branch 136 and may consider this portion of feedback 60 to be text-based customer feedback indicative of a good meal being received at restaurant 58.

Accordingly and in this example, feedback 60 concerns two facets of restaurant 58 (i.e., the service and the meal), wherein user 36 stated (via feedback 60) that they received a good meal even though the service received was poor. Therefore, multiple branches within probabilistic model 100 may be simultaneously activated. Specifically, service branch 104 and meal branch 106 may be simultaneously activated so that the appropriate portion of feedback 60 (e.g., “my waiter was rude”) may be provided to service node 112 while the appropriate portion of feedback 60 (e.g., “my dinner was yummy”) may be provided to meal node 114.

### Probabilistic Model Auto Generation:

While the following discussion concerns the automated generation of a probabilistic model, this is for illustrative purposes only and is not intended to be a limitation of this disclosure, as other configurations are possible and are considered to be within the scope of this disclosure. For example, the following discussion of automated generation may be utilized on any type of model. For example, the following discussion may be applicable to any other form of probabilistic model or any form of generic model (such as Dempster Shaffer theory or fuzzy logic).

As discussed above, probabilistic model 100 may be utilized to categorize content 56, thus allowing the various messages included within content 56 to be routed to (in this simplified example) one of eight nodes (e.g., good service node 126, bad service node 130, good meal node 140, bad meal node 144, good location node 154, bad location node 158, good value node 168, and bad value node 172). For the following example, assume that restaurant 58 is a long-standing and well established eating establishment. Further, assume that content 56 is a very large quantity of voice mail messages (>10,000 messages) that were left by customers of restaurant 58 on a voice-based customer feedback line. Additionally, assume that this very large quantity of voice mail messages (>10,000) have been transcribed into a very large quantity of text-based messages (>10,000).

Probabilistic modeling process 10 may be configured to automatically define probabilistic model 100 based upon content 56. Accordingly, probabilistic modeling process 10 may receive content (e.g., a very large quantity of text-based messages). Probabilistic modeling process 10 may be configured to define one or more probabilistic model variables for probabilistic model 100. For example, probabilistic modeling process 10 may be configured to allow a user of probabilistic modeling process 10 to specify such probabilistic model variables. Another example of such variables may include but is not limited to values and/or ranges of values for a data flow variable. For the following discussion and for this disclosure, examples of “variable” may include but are not limited to variables, parameters, ranges, branches and nodes.

Assume for this example that the user of probabilistic modeling process 10 (be it the owner of restaurant 58 or a third-party service provider) is knowledgeable of e.g., the restaurant business and/or the type of messages included within content 56). For example, assume that the user of probabilistic modeling process 10 read a portion of the messages included within content 56 and determined that the portion of messages reviewed all seem to concern either a) the service, b) the meal, c) the location and/or d) the value of restaurant 58. Accordingly, probabilistic modeling process 10 may be configured to allow a user to define one or more probabilistic model variables, which (in this example) may include one or more probabilistic model branch variables.

Examples of such probabilistic model branch variables may include but are not limited to one or more of: a) a weighting on branches off of a branching node; b) a weighting on values of a variable in the model; c) a minimum acceptable quantity of branches off of the branching node (e.g., branching node 102); d) a maximum acceptable quantity of branches off of the branching node (e.g., branching node 102); and e) a defined quantity of branches off of the branching node (e.g., branching node 102). For example, probabilistic modeling process 10 may be configured to allow a user to define a) a weighting on branches off of a branching node; b) a weighting on values of a variable in the model; c) the maximum number of branching node branches as e.g., five, d) the minimum number of branching node branches as e.g., three and/or e) the quantity of branching node branches as e.g., four.

Specifically and for this example, assume that probabilistic modeling process 10 defines the initial number of branches (i.e., the number of branches off of branching node 102) within probabilistic model 100 as four (i.e., service branch 104, meal branch 106, location branch 108 and value branch 110). When defining the initial number of branches (i.e., the number of branches off of branching node 102) within probabilistic model 100 as four, this may be effectuated in various ways (e.g., manually or algorithmically). Further and when defining probabilistic model 100 based, at least in part, upon content 56 and the one or more model variables (i.e., defining the number of branches off of branching node 102 as four), probabilistic modeling process 10 may process content 56 to identify the pertinent content included within content 56. As discussed above, probabilistic modeling process 10 may identify the pertinent content (included within content 56) and may ignore/remove the irrelevant content.

This type of processing of content 56 may continue for all of the very large quantity of text-based messages (>10,000) included within content 56. And using the probabilistic modeling technique described above, probabilistic modeling process 10 may define a first version of the probabilistic model (e.g., probabilistic model 100) based, at least in part, upon pertinent content found within content 56. Accordingly, a first text-based message included within content 56 may be processed to extract pertinent information from that first message, wherein this pertinent information may be grouped in a manner to correspond (at least temporarily) with the requirement that four branches originate from branching node 102 (as defined above).

As probabilistic modeling process 10 continues to process content 56 to identify pertinent content included within content 56, probabilistic modeling process 10 may identify patterns within these text-based message included within content 56. For example, the messages may all concern one or more of the service, the meal, the location and/or the value of restaurant 58. Further and e.g., using the probabilistic modeling technique described above, probabilistic modeling process 10 may process content 56 to e.g.: a) sort text-based messages concerning the service into positive or negative service messages; b) sort text-based messages concerning the meal into positive or negative meal messages; c) sort text-based messages concerning the location into positive or negative location messages; and/or d) sort text-based messages concerning the value into positive or negative service messages. For example, probabilistic modeling process 10 may define various lists (e.g., lists 128, 132, 142, 146, 156, 160, 170, 174) by starting with a root word (e.g., good or bad) and may then determine synonyms for this words and use those words and synonyms to populate lists 128, 132, 142, 146, 156, 160, 170, 174.

Continuing with the above-stated example, once content 56 (or a portion thereof) is processed by probabilistic modeling process 10, probabilistic modeling process 10 may define a first version of the probabilistic model (e.g., probabilistic model 100) based, at least in part, upon pertinent content found within content 56. Probabilistic modeling process 10 may compare the first version of the probabilistic model (e.g., probabilistic model 100) to content 56 to determine if the first version of the probabilistic model (e.g., probabilistic model 100) is a good explanation of the content.

When determining if the first version of the probabilistic model (e.g., probabilistic model 100) is a good explanation of the content, probabilistic modeling process 10 may use an ML algorithm to fit the first version of the probabilistic model (e.g., probabilistic model 100) to the content, wherein examples of such an ML algorithm may include but are not limited to one or more of: an inferencing algorithm, a learning algorithm, an optimization algorithm, and a statistical algorithm.

For example and as is known in the art, probabilistic model 100 may be used to generate messages (in addition to analyzing them). For example and when defining a first version of the probabilistic model (e.g., probabilistic model 100) based, at least in part, upon pertinent content found within content 56, probabilistic modeling process 10 may define a weight for each branch within probabilistic model 100 based upon content 56. For example, probabilistic modeling process 10 may equally weight each of branches 104, 106, 108, 110 at 25%. Alternatively, if e.g., a larger percentage of content 56 concerned the service received at restaurant 58, probabilistic modeling process 10 may equally weight each of branches 106, 108, 110 at 20%, while more heavily weighting branch 104 at 40%.

Accordingly and when probabilistic modeling process 10 compares the first version of the probabilistic model (e.g., probabilistic model 100) to content 56 to determine if the first version of the probabilistic model (e.g., probabilistic model 100) is a good explanation of the content, probabilistic modeling process 10 may generate a very large quantity of messages e.g., by auto-generating messages using the above-described probabilities, the above-described nodes & node types, and the words defined in the above-described lists (e.g., lists 128, 132, 142, 146, 156, 160, 170, 174), thus resulting in generated content 56′. Generated content 56′ may then be compared to content 56 to determine if the first version of the probabilistic model (e.g., probabilistic model 100) is a good explanation of the content. For example, if generated content 56′ exceeds a threshold level of similarity to content 56, the first version of the probabilistic model (e.g., probabilistic model 100) may be deemed a good explanation of the content. Conversely, if generated content 56′ does not exceed a threshold level of similarity to content 56, the first version of the probabilistic model (e.g., probabilistic model 100) may be deemed not a good explanation of the content.

If the first version of the probabilistic model (e.g., probabilistic model 100) is not a good explanation of the content, probabilistic modeling process 10 may define a revised version of the probabilistic model (e.g., revised probabilistic model 100′). When defining revised probabilistic model 100′, probabilistic modeling process 10 may e.g., adjust weighting, adjust probabilities, adjust node counts, adjust node types, and/or adjust branch counts to define the revised version of the probabilistic model (e.g., revised probabilistic model 100′). Once defined, the above-described process of auto-generating messages (this time using revised probabilistic model 100′) may be repeated and this newly-generated content (e.g., generated content 56″) may be compared to content 56 to determine if e.g., revised probabilistic model 100′ is a good explanation of the content. If revised probabilistic model 100′ is not a good explanation of the content, the above-described process may be repeated until a proper probabilistic model is defined.

The above-described repetitive generation of revised probabilistic models may be accomplished via inferring and/or learning utilizing any inferring or learning algorithm to optimize or estimate the values or distribution over values of variables in a model (e.g., a probabilistic program or other probabilistic model). The variables may control the quantity, composition, and/or grouping of features and feature categories. The inferring or learning algorithm may include Markov Chain Monte Carlo (MCMC). The Markov Chain Monte Carlo (MCMC) may be Metropolis-Hastings MCMC (MH-MCMC). The MH-MCMC may utilize custom proposals to e.g., add, remove, delete, augment, merge, split, or compose features (or categories of features). The inferring or learning algorithm may alternatively (or additionally) include Belief Propagation or Mean-Field algorithms. The inferring or learning algorithm may alternatively (or additionally) include gradient descent based methods. The gradient descent based methods may alternatively (or additionally) include auto-differentiation, back-propagation, and/or black-box variational methods.

### ML (Machine Learning) Objects:

As discussed above, the world of traditional programming was revolutionized through the use of object-oriented programming, wherein portions of code are configured as objects (that effectuate simpler tasks/procedures) that are then compiled/linked together to form a more complex system that effectuates more complex tasks/procedures. Accordingly, probabilistic modeling process 10 may be configured to allow for ML objects to be utilized when generating probabilistic model 100 an/or probabilistic model 100′.

As discussed above, probabilistic model 100 includes four branches off of branching node 102, namely: service branch 104; meal branch 106; location branch 108; and value branch 110 that respectively lead to service node 112, meal node 114, location node 116, and value node 118. Further and as discussed above: service branch 104 leads to service node 112 (which is configured to process service-based content); meal branch 106 leads to meal node 114 (which is configured to process meal-based content); location branch 108 leads to location node 116 (which is configured to process location-based content); and value branch 110 leads to value node 118 (which is configured to process value-based content).

Accordingly, a first portion (e.g., portion 176) of probabilistic model 100 may be configured to process service-based content within content 56. A second portion (e.g., portion 178) of probabilistic model 100 may be configured to configured to process meal-based content within content 56. A third portion (e.g., portion 180) of probabilistic model 100 may be configured to process location-based content within content 56. And a fourth portion (e.g., portion 182) of probabilistic model 100 may be configured to process location-based content within content 56.

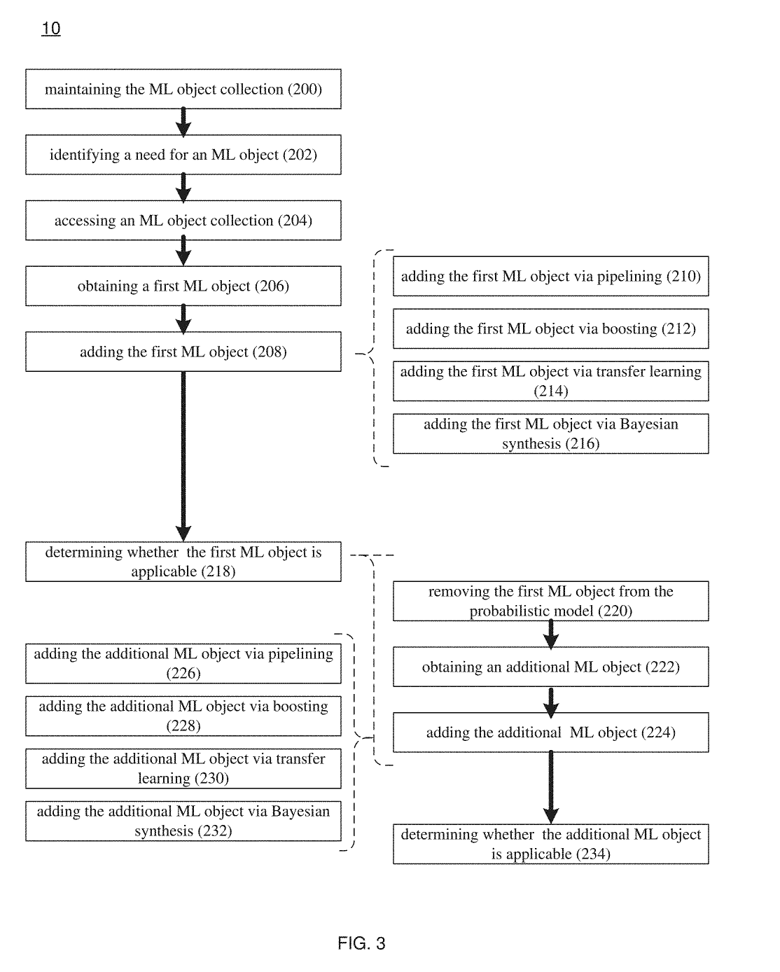

Referring also to FIG. 3, probabilistic modeling process 10 may maintain 200 an ML object collection (e.g., ML object collection 62), wherein ML object collection 62 may define plurality of ML objects 64. For this discussion, each ML object included within plurality of ML objects 64 and defined within ML object collection 62 may be a portion of a probabilistic model that may be configured to effectuate a specific functionality (in a fashion similar to that of a software object used in object oriented programming), wherein the ML objects within plurality of ML objects 64 may be utilized within a probabilistic model (e.g., probabilistic model 100 and/or probabilistic model 100′). For this discussion, ML object collection 62 may be any structure that defines/includes a plurality of ML objects, examples of which may include but are not limited to an ML object repository or another probabilistic model.

Accordingly, the functionality of the first portion (e.g., portion 176) of probabilistic model 100 may be effectuated via an ML object (chosen from plurality of ML objects 64) that is configured to process the service-based content within content 56. Additionally, the functionality of the second portion (e.g., portion 178) of probabilistic model 100 may be effectuated via an ML object (chosen from plurality of ML objects 64) that is configured to process the meal-based content within content 56. Further, the functionality of the third portion (e.g., portion 180) of probabilistic model 100 may be effectuated via an ML object (chosen from plurality of ML objects 64) that is configured to process the location-based content within content 56. And the functionality of the fourth portion (e.g., portion 182) of probabilistic model 100 may be effectuated via an ML object (chosen from plurality of ML objects 64) that is configured to process the location-based content within content 56.

As will be discussed below in greater detail, when probabilistic modeling process 10 is defining probabilistic model 100 (based upon content 56), probabilistic modeling process 10 may utilize one or more ML objects (chosen from plurality of ML objects 64 defined within ML object collection 62).

For example, assume that when defining probabilistic model 100 (based upon content 56), probabilistic modeling process 10 may identify 202 a need for an ML object within probabilistic model 100. Specifically, assume that after probabilistic modeling process 10 defines the four branches off of branching node 102 (e.g., service branch 104, meal branch 106, location branch 108, and value branch 110), probabilistic modeling process 10 identifies 202 the need for an ML object within probabilistic model 100 that may process service-based content (i.e., effectuate the functionality of portion 176 of probabilistic model 100 that is configured to process the service-based content within content 56).

Accordingly and instead of generating portion 176 of probabilistic model 100 organically, probabilistic modeling process 10 may access 204 ML object collection 62 that defines plurality of ML objects 64 and may obtain 206 a first ML object (e.g., ML object 66) selected from plurality of ML objects 64 defined within ML object collection 62.

Continuing with the above-stated example, probabilistic modeling process 10 may identify 202 the need for an ML object within probabilistic model 100 that may process the service-based content (i.e., effectuate the functionality of portion 176). Accordingly, probabilistic modeling process 10 may access 204 ML object collection 62 that defines plurality of ML objects 64 and search for ML objects that may process service-based content. Assume that upon accessing 204 ML object collection 62, probabilistic modeling process 10 may identify ML object 66 as an ML object that may (potentially) process service-based content. Accordingly, probabilistic modeling process 10 may obtain 206 a first ML object (e.g., ML object 66) selected from plurality of ML objects 64 defined within ML object collection 62. Probabilistic modeling process 10 may then test 208 the first ML object (e.g., ML object 66) with probabilistic model 100.

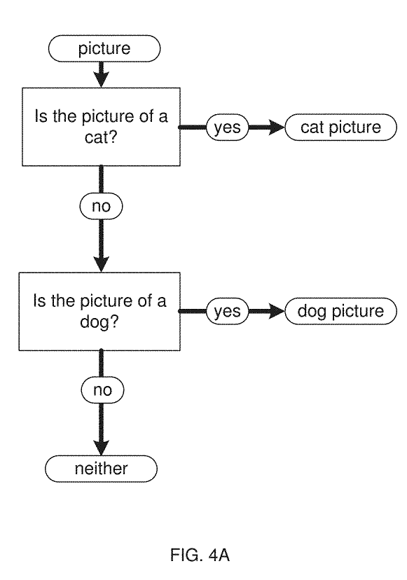

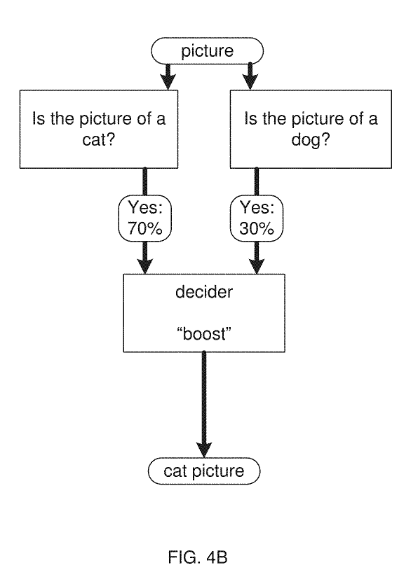

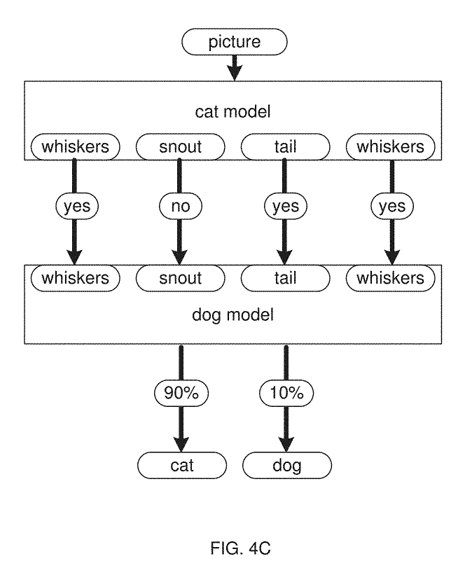

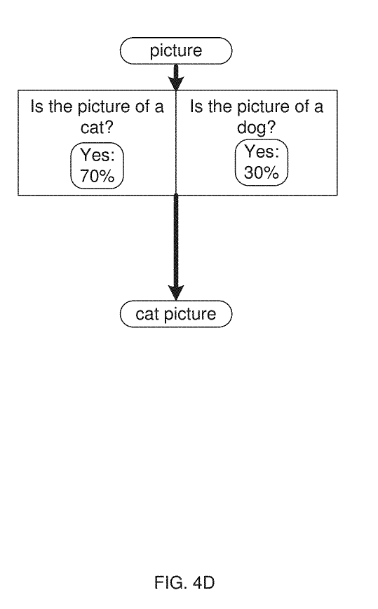

When testing 208 the first ML object (e.g., ML object 66) for probabilistic model 100, probabilistic modeling process 10 may add 210 the first ML object (e.g., ML object 66) to probabilistic model 100 using a pipelining methodology. As is known in the art, pipelining (with respect to machine learning) is a technique that helps automate machine learning workflows, wherein such pipelines enable a sequence of data to be transformed and correlated together in a probabilistic model that can be tested and evaluated to achieve an outcome (whether positive or negative). A graphical example of such a pipelining methodology (being used to analyze a picture of an animal to determine if the animal is a dog or a cat) is shown in FIG. 4A. In such a configuration, two separate probabilistic models may be arranged serially so that a picture of an animal cannot be identified as both a dog and a cat. Unfortunately, if the picture provided to a pipelining methodology illustrates e.g., a dog that looks very similar to a cat (e.g., a Pomeranian), both probabilistic models may consider the picture to be a picture of a cat. Accordingly, the outcome of a pipelining methodology may be determined by the order of the probabilistic models. For example, if the “cat” probabilistic model is positioned first, the picture of a Pomeranian dog may be determined to be a picture of a cat. While if the “dog” probabilistic model is positioned first, the same picture of the Pomeranian dog may be determined to be a picture of a dog.

When testing 208 the first ML object (e.g., ML object 66) for probabilistic model 100, probabilistic modeling process 10 may add 212 the first ML object (e.g., ML object 66) to probabilistic model 100 using a boosting methodology. As is known in the art, boosting (with respect to machine learning) is technique for primarily reducing bias and variance in supervised learning converting weak learning algorithms to strong learning algorithms. A graphical example of such a boosting methodology (being used to analyze a picture of an animal to determine if the animal is a dog or a cat) is shown in FIG. 4B. In such a configuration, two separate probabilistic models may be arranged in parallel. However, both outputs are provided to a decider (i.e., “boost”) that decides which result to use based upon various other factors (e.g., individual confidence scores, etc.).

When testing 208 the first ML object (e.g., ML object 66) for probabilistic model 100, probabilistic modeling process 10 may add 214 the first ML object (e.g., ML object 66) to probabilistic model 100 using a transfer learning methodology. As is known in the art, transfer learning (with respect to machine learning) is a technique that focuses on storing knowledge gained while solving one problem and applying it to a different but related problem. For example, knowledge gained while learning to recognize cats could apply when trying to recognize dogs. A graphical example of such a transfer learning methodology (being used to analyze a picture of an animal to determine if the animal is a dog or a cat) is shown in FIG. 4C. In such a configuration, two separate probabilistic models may be arranged in parallel. However, the first model is trained using labelled pictures of e.g., cats. The trained first model is then reused as the starting point for the second model and is trained using labelled pictures of e.g., dogs. So the second model utilizes knowledge from the first model . . . but the two models are not combined.

When testing 208 the first ML object (e.g., ML object 66) for probabilistic model 100, probabilistic modeling process 10 may add 216 the first ML object (e.g., ML object 66) to probabilistic model 100 using a Bayesian synthesis methodology. As is known in the art, Bayesian synthesis (with respect to machine learning) is a technique in which individual models are combined. This way, the combined models each know the confidence level of the other model. So a model that has a high confidence level may still defer to the other model if that other model has a higher confidence level. A graphical example of such a Bayesian synthesis methodology (being used to analyze a picture of an animal to determine if the animal is a dog or a cat) is shown in FIG. 4D. In such a configuration, the two separate probabilistic models may be combined so that the confidence levels of each model can be shared and a communal decision can be made.

While the above discussion concerns testing 208 the first ML object (e.g., ML object 66) for probabilistic model 100 using one of four methodologies (namely pipelining, boosting, transfer learning and Bayesian synthesis), this is for illustrative purposes only and is not intended to be a limitation of this disclosure, as other configuration are possible and are considered to be within the scope of this disclosure. For example, it is understood that many other methodologies may be utilized by probabilistic modeling process 10 when testing 208 the first ML object (e.g., ML object 66) for probabilistic model 100.

Probabilistic modeling process 10 may determine 218 whether the first ML object (e.g., ML object 66) is applicable with probabilistic model 100. Continuing with the above-stated example in which probabilistic modeling process 10 adds 208 the first ML object (e.g., ML object 66) to probabilistic model 100, probabilistic modeling process 10 may determine 218 whether the first ML object (e.g., ML object 66) is applicable with probabilistic model 100 by performing the comparisons discussed above.

For example, probabilistic modeling process 10 may compare probabilistic model 100 (with ML object 66 being utilized to perform the functionality of portion 176) to content 56 to determine if probabilistic model 100 (with ML object 66 being utilized to effectuate portion 176) is a good explanation of the content. As discussed above, when determining if probabilistic model 100 (with ML object 66 being utilized to effectuate portion 176) is a good explanation of the content, probabilistic modeling process 10 may use an ML algorithm to fit probabilistic model 100 (with ML object 66 being utilized to effectuate portion 176) to the content, wherein examples of such an ML algorithm may include but are not limited to one or more of: an inferencing algorithm, a learning algorithm, an optimization algorithm, and a statistical algorithm.

Specifically and as discussed above, probabilistic modeling process 10 may generate a large quantity of messages e.g., by auto-generating messages using the above-described probabilities, nodes, node types, and words, resulting in generated content 56′. Generated content 56′ may then be compared to content 56 to determine if probabilistic model 100 (with ML object 66 being utilized to effectuate portion 176) is a good explanation of the content. For example, if generated content 56′ exceeds a threshold level of similarity to content 56, probabilistic model 100 (with ML object 66 being utilized to effectuate portion 176) may be deemed a good explanation of the content. Conversely, if generated content 56′ does not exceed a threshold level of similarity to content 56, probabilistic model 100 (with ML object 66 being utilized to effectuate portion 176) may be deemed not a good explanation of the content.

If it is determined that the first ML object (e.g., ML object 66) is applicable with probabilistic model 100 (e.g., is deemed a good explanation of the content), probabilistic modeling process 10 may maintain (e.g., permanently incorporate) the first ML object (e.g., ML object 66) within probabilistic model 100 and may (if needed) continue defining probabilistic model 100 (in e.g., the manner described above).

However, if it is determined that the first ML object (e.g., ML object 66) is not applicable with probabilistic model 100 (e.g., is deemed not a good explanation of the content), probabilistic modeling process 10 may perform various operations as described below.

For example, probabilistic modeling process 10 may not use 220 the first ML object (e.g., ML object 66) with probabilistic model 100. Probabilistic modeling process 10 may then identify an additional ML object (e.g., ML object 68) as an ML object that may (potentially) process service-based content; may obtain 222 the additional ML object (e.g., ML object 68) selected from plurality of ML objects 64 defined within ML object collection 62; and may add 224 the additional ML object (e.g., ML object 68) to probabilistic model 100.

When adding 224 the additional ML object (e.g., ML object 68) to probabilistic model 100, probabilistic modeling process 10 may add 226 the additional ML object (e.g., ML object 68) to probabilistic model 100 using a pipelining methodology. As discussed above, pipelining (with respect to machine learning) is a technique that helps automate machine learning workflows, wherein such pipelines enable a sequence of data to be transformed and correlated together in a probabilistic model that can be tested and evaluated to achieve an outcome (whether positive or negative). As discussed above, due to the manner in which the individual probabilistic models are coupled serially within a pipelining methodology, inaccurate results may occur. Specifically, if the picture provided to a pipelining methodology illustrates e.g., a dog that looks very similar to a cat (e.g., a Pomeranian), the outcome of a pipelining methodology may be determined by the order of the probabilistic models.

When adding 224 the additional ML object (e.g., ML object 68) to probabilistic model 100, probabilistic modeling process 10 may add 228 the additional ML object (e.g., ML object 68) to probabilistic model 100 using a boosting methodology. As discussed above, boosting (with respect to machine learning) is technique for primarily reducing bias and variance in supervised learning converting weak learning algorithms to strong learning algorithms.

When adding 224 the additional ML object (e.g., ML object 68) to probabilistic model 100, probabilistic modeling process 10 may add 230 the additional ML object (e.g., ML object 68) to probabilistic model 100 using a transfer learning methodology. As discussed above, transfer learning (with respect to machine learning) is a technique that focuses on storing knowledge gained while solving one problem and applying it to a different but related problem. For example, knowledge gained while learning to recognize cats could apply when trying to recognize dogs

When adding 224 the additional ML object (e.g., ML object 68) to probabilistic model 100, probabilistic modeling process 10 may add 232 the additional ML object (e.g., ML object 68) to probabilistic model 100 using a Bayesian synthesis methodology. As is known in the art, Bayesian synthesis (with respect to machine learning) is a technique in which individual models are combined. This way, the combined models each know the confidence level of the other model. So a model that has a high confidence level may still defer to the other model if that other model has a higher confidence level.

Again, while the above discussion concerns adding 224 the additional ML object (e.g., ML object 68) to probabilistic model 100 using one of four methodologies (namely pipelining, boosting, transfer learning and Bayesian synthesis), this is for illustrative purposes only and is not intended to be a limitation of this disclosure, as other configuration are possible and are considered to be within the scope of this disclosure. For example, it is understood that many other methodologies may be utilized by probabilistic modeling process 10 when adding 224 the additional ML object (e.g., ML object 68) to probabilistic model 100.

Once added 224, probabilistic modeling process 10 may determine 234 whether the additional ML object (e.g., ML object 68) is applicable with probabilistic model 100. Again, probabilistic modeling process 10 may determine 234 whether the additional ML object (e.g., ML object 68) is applicable with probabilistic model 100 by generating messages and performing the comparisons as discussed above.

This process of not using 220 ML objects with probabilistic model 100; obtaining 222 additional ML objects selected from plurality of ML objects 64 defined within ML object collection 62; adding 224 the additional ML object to probabilistic model 100; and determining 234 whether the additional ML object is applicable with probabilistic model 100 may be repeated until an applicable ML object is identified and added to probabilistic model 100 or until all ML objects within ML object collection 62 have be deemed not applicable.

### Auto-Search:

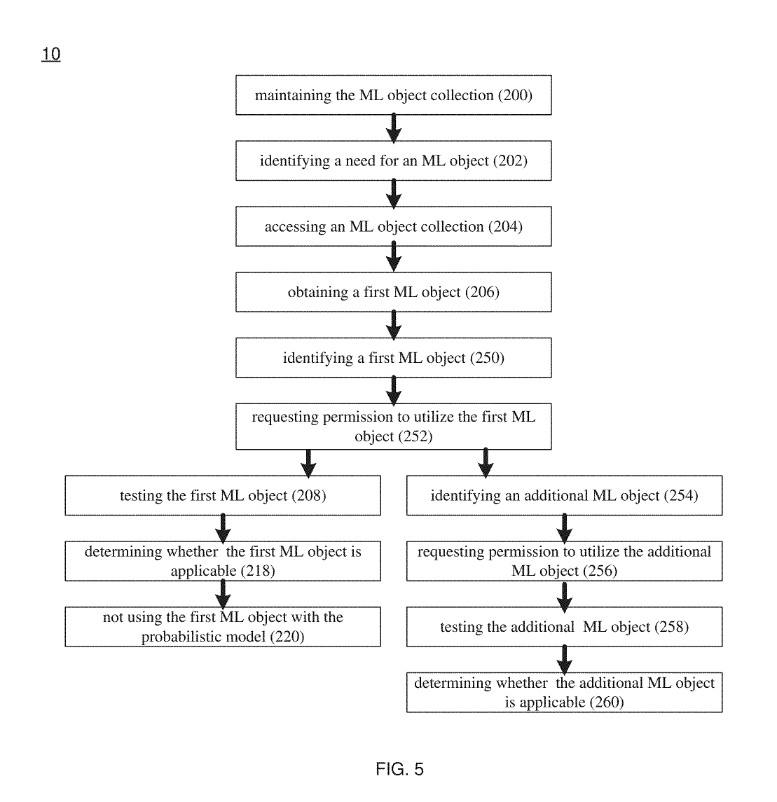

Referring also to FIG. 5 and as will be discussed below in greater detail, probabilistic modeling process 10 may be configured to automate the searching of ML object collection 62 so that an ML object applicable with a probabilistic model (e.g., probabilistic model 100) may be identified.

As discussed above, probabilistic modeling process 10 may maintain 200 an ML object collection (e.g., ML object collection 62), wherein ML object collection 62 may define plurality of ML objects 64. As discussed above, each ML object included within plurality of ML objects 64 and defined within ML object collection 62 may be a portion of a probabilistic model that may be configured to effectuate a specific functionality (in a fashion similar to that of a software object used in object oriented programming). As further discussed above and for this discussion, ML object collection 62 may be any structure that defines/includes a plurality of ML objects, examples of which may include but are not limited to an ML object repository or another probabilistic model.

Further and as discussed above, probabilistic modeling process 10 may identify 202 a need for an ML object within a probabilistic model (e.g., probabilistic model 100). Specifically and as discussed above, assume that after probabilistic modeling process 10 defines the four branches off of branching node 102 (e.g., service branch 104, meal branch 106, location branch 108, and value branch 110), probabilistic modeling process 10 identifies 202 the need for an ML object within probabilistic model 100 that may process service-based content (i.e., effectuate the functionality of portion 176 of probabilistic model 100 that is configured to process the service-based content within content 56).

As discussed above, probabilistic modeling process 10 may access 204 an ML object collection (e.g., ML object collection 62) that defines plurality of ML objects 64 and may identify 250 a first ML object (e.g., ML object 66) chosen from plurality of ML objects 64 defined within the ML object collection (e.g., ML object collection 62). Assume that upon accessing 204 ML object collection 62, probabilistic modeling process 10 may identify 250 ML object 66 as an ML object that may (potentially) process the service-based content within content 56.

Once identified 250, probabilistic modeling process 10 may request 252 permission to utilize the first ML object (e.g., ML object 66). When requesting 252 permission to utilize the first ML object (e.g., ML object 66), probabilistic modeling process 10 may notify a user (e.g., administrator 70 of probabilistic modeling process 10) that an ML object (e.g., ML object 66) was identified 250 that may (potentially) process the service-based content within content 56, asking for permission to utilize the same.

If the requested permission to utilize the first ML object (e.g., ML object 66) is granted, the first ML object (e.g., ML object 66) may be tested 208 with the probabilistic model (e.g., probabilistic model 100). Once tested 208, probabilistic modeling process 10 may determine 218 whether the first ML object (e.g., ML object 66) is applicable with the probabilistic model (e.g., probabilistic model 100).

Probabilistic modeling process 10 may determine 218 whether the first ML object (e.g., ML object 66) is applicable with probabilistic model 100 by performing the above-described comparisons. As discussed above, probabilistic modeling process 10 may use an ML algorithm to fit probabilistic model 100 to the content, wherein examples of such an ML algorithm may include but are not limited to one or more of: an inferencing algorithm, a learning algorithm, an optimization algorithm, and a statistical algorithm.

As discussed above and as is known in the art, probabilistic model 100 may be used to generate messages (in addition to analyzing them). Accordingly and when determining 218 whether the first ML object (e.g., ML object 66) is applicable with probabilistic model 100, probabilistic modeling process 10 may generate a very large quantity of messages e.g., by auto-generating messages using probabilistic model 100 (with ML object 66 installed), thus resulting in generated content 56′. Probabilistic modeling process 10 may then compare generated content 56′ to content 56 to determine if probabilistic model 100 (with ML object 66 installed) is a good explanation of content 56. And if probabilistic model 100 (with ML object 66 installed) is a good explanation of content 56, probabilistic modeling process 10 may determine 218 that the first ML object (e.g., ML object 66) is applicable with the probabilistic model (e.g., probabilistic model 100).

If it is determined 218 that the first ML object (e.g., ML object 66) is not applicable with the probabilistic model (e.g., probabilistic model 100), probabilistic modeling process 10 may not use 220 the first ML object (e.g., ML object 66) with the probabilistic model (e.g., probabilistic model 100) and additional ML objects may be sought. Conversely, it is determined 218 that the first ML object (e.g., ML object 66) is applicable with the probabilistic model (e.g., probabilistic model 100), probabilistic modeling process 10 may utilize the first ML object (e.g., ML object 66) within the probabilistic model (e.g., probabilistic model 100).

If the requested permission to utilize the first ML object (e.g., ML object 66) is not granted, probabilistic modeling process 10 may identify 254 an additional ML object (e.g., ML object 68) chosen from plurality of ML objects 64 defined within ML object collection 62 (e.g., ML object collection 62) and permission to utilize the additional ML object (e.g., ML object 68) may be requested 256.

If the requested permission to utilize the additional ML object (e.g., ML object 68) is granted, probabilistic modeling process 10 may test 258 the additional ML object (e.g., ML object 68) with the probabilistic model (e.g., probabilistic model 100) and may determine 260 (in the manner described above) whether the additional ML object (e.g., ML object 68) is applicable with the probabilistic model (e.g., probabilistic model 100).

This process of not using 220 ML objects with probabilistic model 100; identifying 254 additional ML objects selected from plurality of ML objects 64 defined within ML object collection 62; testing 258 the additional ML object for probabilistic model 100; and determining 260 whether the additional ML object is applicable with probabilistic model 100 may be repeated until an applicable ML object is identified and added to probabilistic model 100 or until all ML objects within ML object collection 62 have be deemed not applicable.

### Access Control:

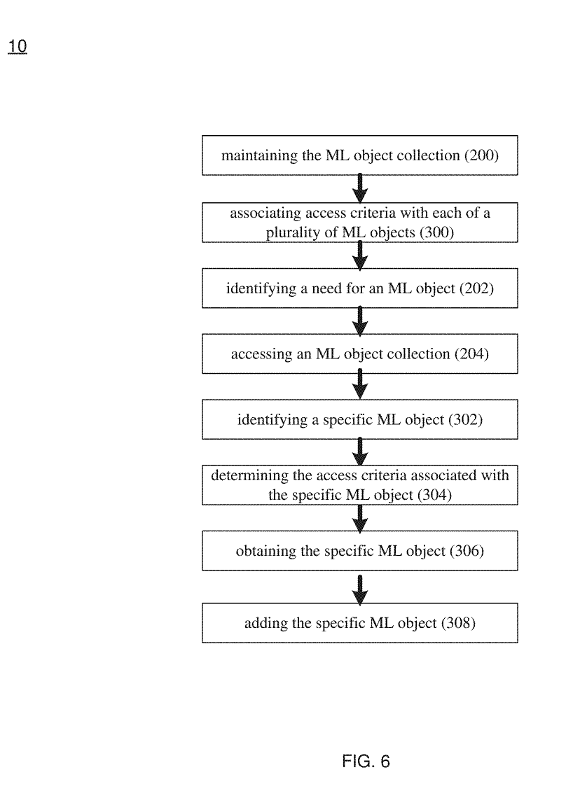

Referring also to FIG. 6 and as will be discussed below in greater detail, probabilistic modeling process 10 may be configured to allow the access to one or more of plurality of ML objects 64 defined within ML object collection 62 to be controlled/regulated.

As discussed above, probabilistic modeling process 10 may maintain 200 an ML object collection (e.g., ML object collection 62), wherein ML object collection 62 may define plurality of ML objects 64. As discussed above, each ML object included within plurality of ML objects 64 and defined within ML object collection 62 may be a portion of a probabilistic model that may be configured to effectuate a specific functionality (in a fashion similar to that of a software object used in object oriented programming). As further discussed above and for this discussion, ML object collection 62 may be any structure that defines/includes a plurality of ML objects, examples of which may include but are not limited to an ML object repository or another probabilistic model.

Probabilistic modeling process 10 may associate 300 access criteria with each of plurality of ML objects 64. Specifically, probabilistic modeling process 10 may be configured to associate 300 access criteria with each of plurality of ML objects 64 to regulate who can access an ML object within plurality of ML objects 64. For example, such access criteria may define the type of user who can access a particular ML object. Accordingly and within a company, certain ML objects may be available to people belonging to certain groups or teams, while the same ML objects may be unavailable to people on other groups or teams. Further and within a company, certain ML objects may be available to people that have a certain level, permission, key or authority, wherein e.g. management level users may be able to access certain ML objects, while the same ML objects may be unavailable to non-management level users. Additionally, certain ML objects may be available to various users provided that the user is not associated with a competitor of the owner of the ML object. Further still, certain ML objects may be available to various users provided that the various users are willing to pay a licensing/use fee. Accordingly and by associating such access criteria with each of the ML objects included within plurality of ML objects 64, the access to these individual ML objects may be controlled/regulated.

Assume for illustrative purposes that probabilistic modeling process 10 may identify 202 a need for an ML object within a probabilistic model (e.g., probabilistic model 100). Specifically and as discussed above, assume that after probabilistic modeling process 10 defines the four branches off of branching node 102 (e.g., service branch 104, meal branch 106, location branch 108, and value branch 110), probabilistic modeling process 10 identifies 202 the need for an ML object within probabilistic model 100 that may process service-based content (i.e., effectuate the functionality of portion 176 of probabilistic model 100 that is configured to process the service-based content within content 56).

As discussed above, probabilistic modeling process 10 may access 204 the ML object collection (e.g., ML object collection 62) and may identify 302 a specific ML object (e.g., ML object 66) chosen from plurality of ML objects 64 defined within the ML object collection (e.g., ML object collection 62). Assume that upon accessing 204 ML object collection 62, probabilistic modeling process 10 may identify 302 ML object 66 as an ML object that may (potentially) process service-based content within content 56. Additionally, probabilistic modeling process 10 may determine 304 the access criteria associated with the specific ML object (e.g., ML object 66).

Probabilistic modeling process 10 may obtain 306 the specific ML object (e.g., ML object 66) if a requestor (e.g., a user) meets/accepts the access criteria of the specific ML object (e.g., ML object 66). As discussed above, this access criteria may define a usage fee for the specific ML object (e.g., ML object 66) and meeting/accepting the access criteria may include the requestor (e.g., a user) agreeing to pay the usage fee. For example, the requestor (e.g., a user) may need to agree to pay a $20 usage fee in order to access the specific ML object (e.g., ML object 66) within probabilistic model 100.

Additionally, the access criteria may define a requestor status and meeting/accepting the access criteria may include the requestor (e.g., the user) meeting the requestor status. For example, the requester (e.g., the user) may need to be on a certain team, be a member of a certain group, have a certain status, be employed by a certain company, etc. Accordingly, the requestor status may include one or more of: the requestor being associated with a group; the requestor being associated with an entity; the requestor being associated with a class; the requestor being associated with a level; the requestor having one or more required keys; the requestor having one or more required permissions; and the requestor having a certain authority.

Probabilistic modeling process 10 may add 308 the specific ML object (e.g., ML object 66) to the probabilistic model (e.g., probabilistic model 100). Once added 308, probabilistic modeling process 10 may determine (in the manner described above) whether the specific ML object (e.g., ML object 66) is applicable with the probabilistic model (e.g., probabilistic model 100).

### Version Control:

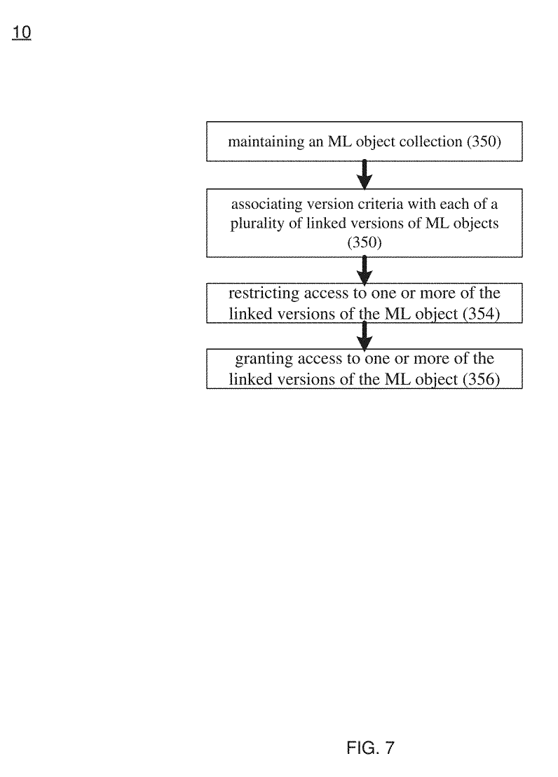

Referring also to FIG. 7 and as will be discussed below in greater detail, probabilistic modeling process 10 may be configured to maintain and link a plurality of versions of an ML object in a fashion similar to a version management system for documents or software.

As discussed above, probabilistic modeling process 10 may maintain 350 an ML object collection (e.g., ML object collection 62), wherein ML object collection 62 may define at least one ML object (e.g., plurality of ML objects 64). As discussed above, each ML object included within plurality of ML objects 64 and defined within ML object collection 62 may be a portion of a probabilistic model that may be configured to effectuate a specific functionality (in a fashion similar to that of a software object used in object oriented programming). As further discussed above and for this discussion, ML object collection 62 may be any structure that defines/includes a plurality of ML objects, examples of which may include but are not limited to an ML object repository or another probabilistic model.

At least one of the ML objects (e.g., ML object 66) defined within plurality of ML objects 64 may define a plurality of linked versions of the ML object (e.g., a plurality of temporally varying versions of the ML object). Assume for illustrative purposes that ML object 66 includes three versions, namely: the current version (e.g., ML object 66), an older version (e.g., ML object 66.1), and an oldest version (e.g., ML object 66.2).

There are many benefits to probabilistic modeling process 10 maintaining and linking a plurality of versions of an ML object, examples of which may include but are not limited to:
maintaining time/date stamps for each version of an ML object.
storing a pointer to (or identifier for) the data set(s) that a given version of an ML object was trained on.
automating the identification of which version of an ML object would be most useful for use in a probabilistic model.
providing a natural language description of the idea that the ML object understands/represents.
providing a graphical display of all of the versions of an ML object and their lineages/change history.
storing metadata about how well each ML objects works on each data set.
implementing a novel management process. For example, in a standard software versioning system, a pull request process is used to get a group of people to review code before it becomes the new version and replaces an old version of that module within the system. An ML object version control system as implemented by probabilistic modeling process 10 may include a similar pull request process, which may include human review or the system could simply determine that the new version of the ML object would be a better choice for use within the collection. This may result in e.g., an increase in the accuracy of the probabilistic model on data and/or in the displaying of standalone accuracy that is better than the previous version of the model component.

Probabilistic modeling process 10 may associate 352 version criteria with each of the plurality of linked versions of an ML object (e.g., ML object 66). Accordingly, probabilistic modeling process 10 may be configured to associate 352 version criteria with the current version (e.g., ML object 66), the older version (e.g., ML object 66.1), and the oldest version (e.g., ML object 66.2) to regulate who can access a specific version of an ML object (e.g., ML object 66) within plurality of ML objects 64.

Such version criteria may define the type of user who can access a specific linked version of an ML object (e.g., ML object 66). Accordingly and within a company, certain versions of ML objects may be available to people belonging to certain groups or teams, while the same versions of ML objects may be unavailable to people on other groups or teams. Further and within a company, certain versions of ML objects may be available to people that have a certain level, permission, key or authority, wherein e.g. management level users may be able to access certain versions of ML objects, while the same versions of ML objects may be unavailable to non-management level users. Additionally, certain versions of ML objects may be available to various users provided that the users are not associated with a competitor of the owner of the versions of ML object. Further still, certain versions of ML objects may be available to various users provided that the various users are willing to pay a licensing/use fee. Accordingly and by associating such version criteria with each linked version of the ML objects included within plurality of ML objects 64, the access to these individual versions of the ML objects may be controlled/regulated.

Probabilistic modeling process 10 may further be configured to: restrict 354 access to one or more of the linked versions (e.g., ML object 66, 66.1, 66.2) of the ML object based, at least in part, upon the version criteria; and/or grant 356 access to one or more of the linked versions (e.g., ML object 66, 66.1, 66.2) of the ML object based, at least in part, upon the version criteria.

As discussed above, this version criteria may define a usage fee for certain versions of the ML object (e.g., ML object 66) that the requestor (e.g., a user) must meet/accept. For example, the requestor (e.g., a user) may need to agree to pay a $20 usage fee in order to access certain linked versions of the ML object (e.g., ML object 66). Further and as discussed above, the version criteria may define a requestor status that the requestor (e.g., the user) must meet/accept. For example, the requester (e.g., the user) may need to be on a certain team, be a member of a certain group, have a certain status, be employed by a certain company, etc. Accordingly, the requestor status may include one or more of: the requestor being associated with a group; the requestor being associated with an entity; the requestor being associated with a class; the requestor being associated with a level; the requestor having one or more required keys; the requestor having one or more required permissions; and the requestor having a certain authority.

Usable vs. Private:

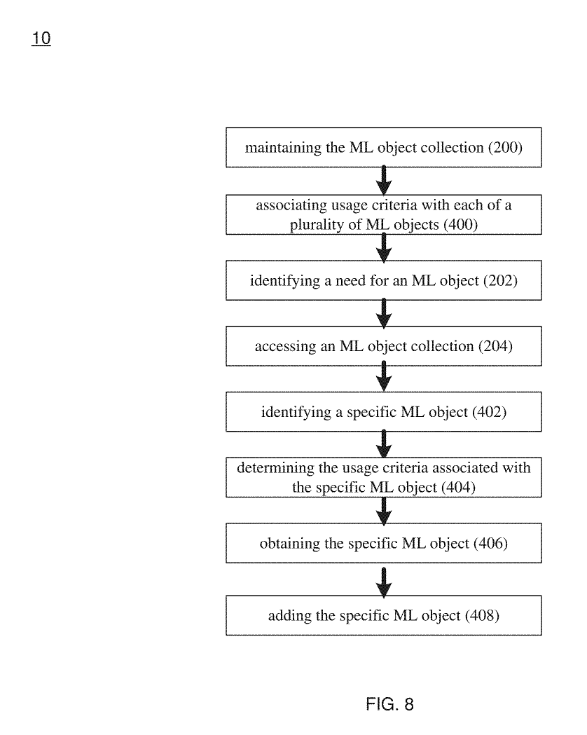

Referring also to FIG. 8 and as will be discussed below in greater detail, probabilistic modeling process 10 may be configured to allow the usage of one or more of plurality of ML objects 64 defined within ML object collection 62 to be controlled/regulated.

As discussed above, probabilistic modeling process 10 may maintain 200 an ML object collection (e.g., ML object collection 62), wherein ML object collection 62 may define plurality of ML objects 64. As discussed above, each ML object included within plurality of ML objects 64 and defined within ML object collection 62 may be a portion of a probabilistic model that may be configured to effectuate a specific functionality (in a fashion similar to that of a software object used in object oriented programming). As further discussed above and for this discussion, ML object collection 62 may be any structure that defines/includes a plurality of ML objects, examples of which may include but are not limited to an ML object repository or another probabilistic model.

Probabilistic modeling process 10 may associate 400 usage criteria with each of plurality of ML objects 64. For the following discussion, plurality of ML objects 64 may include one or more discrete and unique ML objects (e.g., ML object 66, 68) and/or one or more unique versions of a common ML object (e.g., ML objects 66, 66.1, 66.2). Specifically, probabilistic modeling process 10 may be configured to associate 400 usage criteria with each of plurality of ML objects 64 to regulate the usage of an ML object within plurality of ML objects 64. For example, such usage criteria may define the type of user who can access a particular ML object. Accordingly and within a company, certain ML objects may be available to people belonging to certain groups or teams, while the same ML objects may be unavailable to people on other groups or teams. Further and within a company, certain ML objects may be available to people that have a certain level, permission, key or authority, wherein e.g. management level users may be able to access certain ML objects, while the same ML objects may be unavailable to non-management level users. Additionally, certain ML objects may be available to various users provided that the user is not associated with a competitor of the owner of the ML object. Further still, certain ML objects may be available to various users provided that the various users are willing to pay a licensing/use fee. Accordingly and by associating such usage criteria with each of the ML objects included within plurality of ML objects 64, the usage to these individual ML objects may be controlled/regulated.

Further and as discussed above, probabilistic modeling process 10 may identify 202 a need for an ML object within a probabilistic model (e.g., probabilistic model 100). As discussed above, assume again that after probabilistic modeling process 10 defines the four branches off of branching node 102 (e.g., service branch 104, meal branch 106, location branch 108, and value branch 110), probabilistic modeling process 10 identifies 202 the need for an ML object within probabilistic model 100 that may process service-based content (i.e., effectuate the functionality of portion 176 of probabilistic model 100 that is configured to process the service-based content within content 56).

As discussed above, probabilistic modeling process 10 may access 204 the ML object collection (e.g., ML object collection 62) and may identify 402 a specific ML object chosen from the plurality of ML objects defined within the ML object collection (e.g., ML object collection 62). Assume that upon accessing 204 ML object collection 62, probabilistic modeling process 10 may identify 402 ML object 66 as an ML object that may (potentially) process service-based content within content 56. Additionally, probabilistic modeling process 10 may determine 404 the usage criteria associated with the specific ML object (e.g., ML object 66).

Probabilistic modeling process 10 may obtain 406 the specific ML object if a requestor meets/accepts the usage criteria of the specific ML object. As discussed above, this usage criteria may define a usage fee for the specific ML object (e.g., ML object 66) and meeting/accepting the usage criteria may include the requestor (e.g., a user) agreeing to pay the usage fee. For example, the requestor (e.g., a user) may need to agree to pay a $20 usage fee in order to use the specific ML object (e.g., ML object 66) within probabilistic model 100.

Additionally, the usage criteria may define a requestor status and meeting/accepting the usage criteria may include the requestor (e.g., the user) meeting the requestor status. For example, the requester (e.g., the user) may need to be on a certain team, be a member of a certain group, have a certain status, be employed by a certain company, etc. Accordingly, the requestor status may include one or more of: the requestor being associated with a group; the requestor being associated with an entity; the requestor being associated with a class; the requestor being associated with a level; the requestor having one or more required keys; the requestor having one or more required permissions; and the requestor having a certain authority.

As discussed above, probabilistic modeling process 10 may be configured to allow the usage of one or more of plurality of ML objects 64 defined within ML object collection 62 to be controlled/regulated. For example and through the use of the above-described usage criteria, certain ML objects (e.g., ML object 66) may be freely usable by anyone without requiring the user to pay a licensing fee, as the usage criteria may define the specific ML object (e.g., ML object 66) as being freely usable. Conversely and through the use of the above-described usage criteria, certain ML objects (e.g., ML object 66) may only be usable by someone willing to pay a licensing fee, as the usage criteria may define the specific ML object (e.g., ML object 66) as requiring that a licensing be paid. Additionally and through the use of the above-described usage criteria, certain ML objects (e.g., ML object 66) may only be usable by someone that is not in competition with the owner of the specific ML object (e.g., ML object 66), as the usage criteria may define no competitive overlap with respect to specific ML object (e.g., ML object 66). For example, if ML object 66 is a customer satisfaction ML object that was developed by (and is owned by) ABC Coffee Roasters, the usage criteria associated with ML object 66 may prohibit XYZ Coffee Roasters from using ML object 66 (as they are competitors) while allowing Super Slice Pizza to use ML object 66 (as they are not competitors).

Probabilistic modeling process 10 may add 408 the specific ML object (e.g., ML object 66) to the probabilistic model (e.g., probabilistic model 100). Once added 408, probabilistic modeling process 10 may determine (in the manner described above) whether the specific ML object (e.g., ML object 66) is applicable with the probabilistic model (e.g., probabilistic model 100.

### Auto-Use:

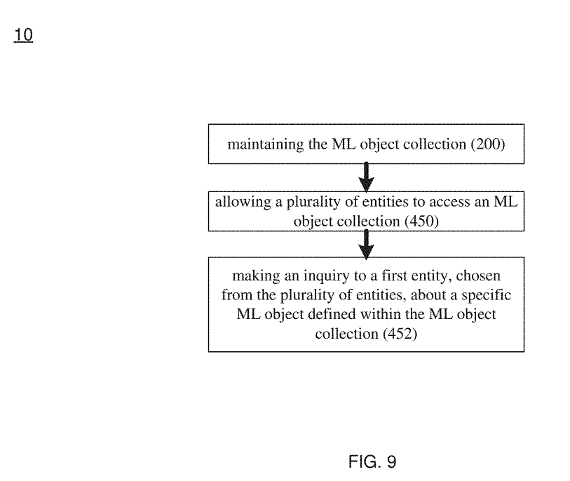

Referring also to FIG. 9 and as will be discussed below in greater detail, probabilistic modeling process 10 may be configured to allow the usage of one or more of plurality of ML objects 64 defined within ML object collection 62 to be partially automated by seeking user approval concerning the same.

As discussed above, probabilistic modeling process 10 may maintain 200 the ML object collection (e.g., ML object collection 62), wherein ML object collection 62 may define plurality of ML objects 64. As discussed above, each ML object included within plurality of ML objects 64 and defined within ML object collection 62 may be a portion of a probabilistic model that may be configured to effectuate a specific functionality (in a fashion similar to that of a software object used in object oriented programming). As further discussed above and for this discussion, ML object collection 62 may be any structure that defines/includes a plurality of ML objects, examples of which may include but are not limited to an ML object repository or another probabilistic model.

Probabilistic modeling process 10 may allow 450 a plurality of entities to access an ML object collection (e.g., ML object collection 62) that defines plurality of ML objects 64. For example, probabilistic modeling process 10 may be configured to allow 450 user 36, user 38, user 40 and/or user 42 to access ML object collection 62 that defines plurality of ML objects 64.

Probabilistic modeling process 10 may be configured to monitor the various ML objects (e.g., plurality of ML object 64) defined within ML object collection 62 to determine which (if any) of plurality of ML object 64 may be usable by one or more of the entities (e.g., users 36, 38, 40, 42) accessing the ML object collection (e.g., ML object collection 62).

When a possible use of an ML object is identified by probabilistic modeling process 10, probabilistic modeling process 10 may make 452 an inquiry to a first entity, chosen from the plurality of entities (e.g., users 36, 38, 40, 42), about a specific ML object defined within the ML object collection (e.g., ML object collection 62).

For example, assume that the first entity is user 36 who owns the specific ML object (e.g., ML object 66), wherein the inquiry made 452 by probabilistic modeling process 10 may concern whether the first entity (e.g., user 36) is interested in allowing a second entity (e.g., user 38), chosen from the plurality of entities (e.g., users 36, 38, 40, 42), to use the specific ML object (e.g., ML object 66).

For example and as discussed above, assume that ML object 66 is a customer satisfaction ML object that was developed by (and is owned by) ABC Coffee Roasters (with which user 36 is associated). Accordingly, if user 38 is associated XYZ Coffee Roasters (a competitor of ABC Coffee Roasters), user 36 may not be interested in allowing user 38 to use the specific ML object (e.g., ML object 66) and may negatively respond to the inquiry made 452 by probabilistic modeling process 10. However, if user 38 is associated with Super Slice Pizza (not a competitor of ABC Coffee Roasters), user 36 may be interested in allowing user 38 to use the specific ML object (e.g., ML object 66) and may positively respond to the inquiry made 452 by probabilistic modeling process 10. When making 452 the above-described inquiry, probabilistic modeling process 10 may e.g., render a message on a display screen of client electronic devices 28 associated with user 36 to inquire as to whether e.g., user 36 is interested in allowing user 38 to use ML object 66.

Conversely, the inquiry made 452 by probabilistic modeling process 10 may concern whether the first entity (e.g., user 36) is interested in maintaining the specific ML object (e.g., ML object 66) private. For example, if probabilistic modeling process 10 notices that the competition of ABC Coffee Roasters (which owns ML object 66) are in need of a customer satisfaction ML object (e.g., ML object 66), the inquiry made 452 by probabilistic modeling process 10 may concern whether the first entity (e.g., user 36) is interested in maintaining the specific ML object (e.g., ML object 66) private (for competitive advantage purposes).

For the next example, assume that a second entity (e.g., user 38), chosen from the plurality of entities (e.g., users 36, 38, 40, 42), owns the specific ML object (e.g., ML object 66), wherein the inquiry made 452 by probabilistic modeling process 10 may concern whether the first entity (e.g., user 36) is interested in using the specific ML object (e.g., ML object 66). Continuing with the above-stated example, if the second entity (e.g., user 38) is a coffee roaster that owns the customer satisfaction ML object (e.g., ML object 66) and probabilistic modeling process 10 believes that the first entity (e.g., user 36), who is a pizza manufacture, may be interested in using the specific ML object (e.g., ML object 66), probabilistic modeling process 10 may make 452 an inquiry to the first entity (e.g., user 36) concerning whether the first entity (e.g., user 36) is interested in using the specific ML object (e.g., ML object 66) owned by (in this example) the second entity (e.g., user 38). When making 452 the above-described inquiry, probabilistic modeling process 10 may e.g., render a message on a display screen of client electronic devices 28 associated with user 36 to inquire as to whether e.g., user 36 is interested in using ML object 66.

### Synonym Finder (Word):

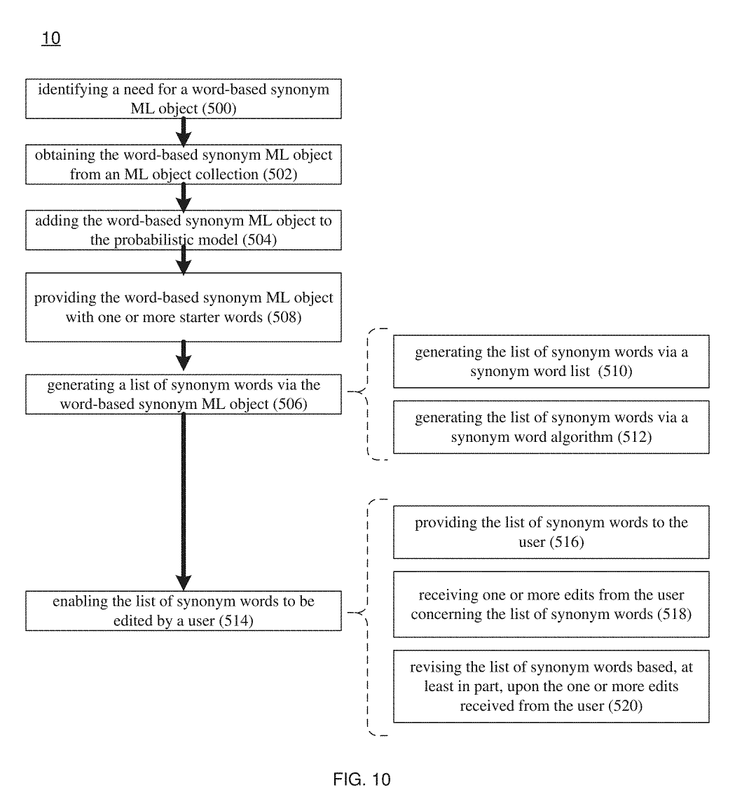

Referring also to FIG. 10 and as will be discussed below in greater detail, probabilistic modeling process 10 may be configured to automate the generation of a list of synonym words that may be edited/revised by a user.

As discussed above, probabilistic modeling process 10 may define various lists (e.g., lists 128, 132, 142, 146, 156, 160, 170, 174) by starting with one or more root word and may then determine synonyms for these root word(s) and use those root words and synonyms to populate lists 128, 132, 142, 146, 156, 160, 170, 174.

Accordingly and when generating probabilistic model 100, probabilistic modeling process 10 may identify 500 a need for a word-based synonym ML object (e.g., ML object 68) within a probabilistic model (e.g., probabilistic model 100). For example, a word-based synonym ML object (e.g., ML object 68) may be utilized within probabilistic model 100 to generate single word synonyms for one or more root words.

Once a word-based synonym ML object (e.g., ML object 68) is identified, probabilistic modeling process 10 may obtain 502 the word-based synonym ML object (e.g., ML object 68) from an ML object collection (e.g., ML object collection 62) that defines plurality of ML objects 64. Probabilistic modeling process 10 may then add 504 the word-based synonym ML object (e.g., ML object 68) to the probabilistic model (e.g., probabilistic model 100) and generate 506 a list of synonym words via the word-based synonym ML object (e.g., ML object 68). For this discussion, the list of synonym words may be a complete list (i.e., a list that defines every synonym word for a specific word), a partial list (i.e., a list that defines some synonym words, but not every synonym word, for a specific word), or a single synonym word (i.e., a list that define one synonym word for a specific word).

For example, probabilistic modeling process 10 may provide 508 the word-based synonym ML object (e.g., ML object 68) with one or more starter words from which the list of synonym words is generated. For example, if the list of synonym words being generated 506 is seeded with the starter word “car”, probabilistic modeling process 10 may generate 506 a list of synonym words via the word-based synonym ML object (e.g., ML object 68) that may include e.g., automobile, limousine, convertible, wagon, hatchback, sedan, coupe, gas guzzler and hardtop.

When generating 506 a list of synonym words (for car) via the word-based synonym ML object (e.g., ML object 68), probabilistic modeling process 10 may generate 510 the list of synonym words (for car) via a synonym word list (via e.g., a remotely accessible electronic thesaurus).

When generating 506 a list of synonym words (for car) via the word-based synonym ML object (e.g., ML object 68), probabilistic modeling process 10 may generate 512 the list of synonym words (for car) via a synonym word algorithm (via e.g., a machine learning algorithm that processes content in order to identify words having similar meanings).

Probabilistic modeling process 10 may enable 514 the list of synonym words to be edited by a user. For example, a user (e.g., user 36, 38, 40, 42) may be enabled 514 to edit the list of synonym words (for car) by e.g., adding words to the list or removing words from the list. For example, if the user is producing probabilistic model 100 for use within an energy conservation organization, the user may wish to edit the list of synonym words (for car) to e.g., remove “gas guzzler” and to add subcompact.

For example and when enabling 514 the list of synonym words (for car) to be edited by a user (e.g., user 46, 38, 40 42), probabilistic modeling process 10 may provide 516 the list of synonym words (for car) to the user (e.g., user 36, 38, 40, 42). For example, probabilistic modelling process 10 may render the list of synonym words (for car) on a display screen of a client electronic device utilized by the user. Further and when enabling 514 the list of synonym words (for car) to be edited by a user (e.g., user 36, 38, 40, 42), probabilistic modeling process 10 may receive 518 one or more edits from the user (e.g., user 36, 38, 40, 42) concerning the list of synonym words (for car) and may revise 520 the list of synonym words (for car) based, at least in part, upon the one or more edits received from the user (e.g., user 36, 38, 40, 42). For example, probabilistic modelling process 10 may receive 518 edits provided by the user (e.g., user 36, 38, 40, 42) via the client electronic device utilized by the user (e.g., user 36, 38, 40, 42), wherein these edits may be used to revise 520 the list of synonym words (for car).

### Synonym Finder (Phrase):

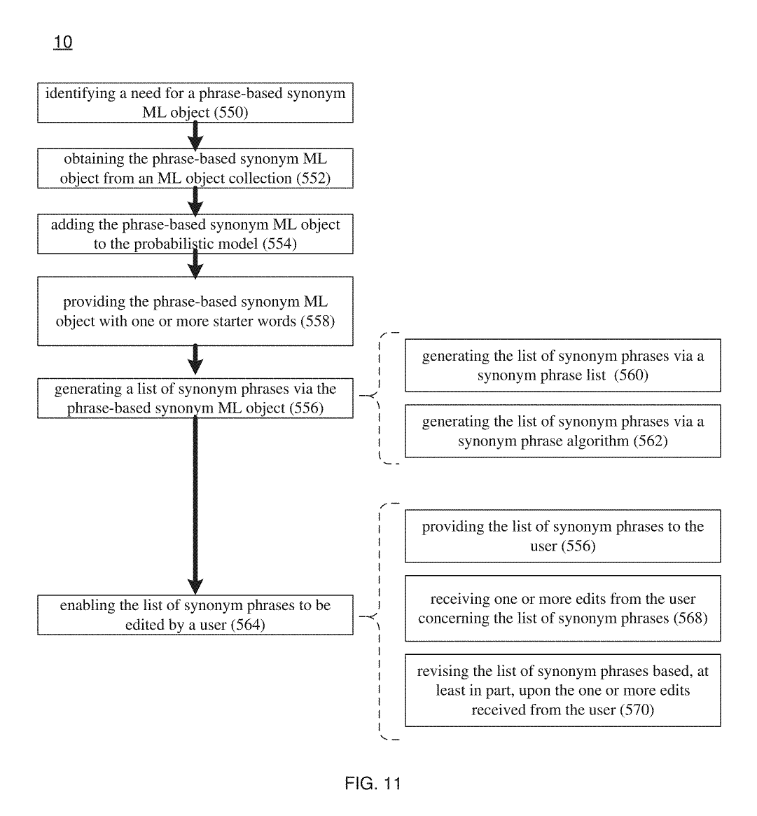

Referring also to FIG. 11 and as will be discussed below in greater detail, probabilistic modeling process 10 may be configured to automate the generation of a list of synonym phrases that may be edited/revised by a user.

As discussed above, probabilistic modeling process 10 may define various lists (e.g., lists 128, 132, 142, 146, 156, 160, 170, 174) by starting with one or more root word and may then determine synonyms for these root word(s) and use those root words and synonyms to populate lists 128, 132, 142, 146, 156, 160, 170, 174.

Accordingly and when generating probabilistic model 100, probabilistic modeling process 10 may identify 550 a need for a phrase-based synonym ML object (e.g., ML object 68) within a probabilistic model (e.g., probabilistic model 100). For example, a phrase-based synonym ML object (e.g., ML object 68) may be utilized within probabilistic model 100 to generate multi-word (i.e., phrase) synonyms for one or more root words/phrases.

Once a phrase-based synonym ML object (e.g., ML object 68) is identified, probabilistic modeling process 10 may obtain 552 the phrase-based synonym ML object (e.g., ML object 68) from an ML object collection (e.g., ML object collection 62) that defines plurality of ML objects 64. Probabilistic modeling process 10 may then add 554 the phrase-based synonym ML object (e.g., ML object 68) to the probabilistic model (e.g., probabilistic model 100) and generate 556 a list of synonym phrases via the phrase-based synonym ML object (e.g., ML object 68). For this discussion, the list of synonym phrases may be a complete list (i.e., a list that defines every synonym phrase for a specific phrase), a partial list (i.e., a list that defines some synonym phrases, but not every synonym phrase, for a specific phrase), or a single synonym phrase (i.e., a list that define one synonym phrase for a specific phrase).

For example, probabilistic modeling process 10 may provide 558 the phrase-based synonym ML object (e.g., ML object 68) with one or more starter phrases from which the list of synonym phrases is generated. For example, if the list of synonym phrases being generated 556 is seeded with the starter phrase “not happy”, probabilistic modeling process 10 may generate 556 a list of synonym phrases via the phrase-based synonym ML object (e.g., ML object 68) that may include e.g., totally awful, abject failure, very disappointed, and f'ed up.

When generating 556 a list of synonym phrases (for not happy) via the phrase-based synonym ML object (e.g., ML object 68), probabilistic modeling process 10 may generate 560 the list of synonym phrases (for not happy) via a synonym phrase list (via e.g., a remotely accessible electronic thesaurus).

When generating 556 a list of synonym words (for not happy) via the phrase-based synonym ML object (e.g., ML object 68), probabilistic modeling process 10 may generate 562 the list of synonym phrases (for not happy) via a synonym phrase algorithm (via e.g., a machine learning algorithm that processes content in order to identify phrases having similar meanings).

Probabilistic modeling process 10 may enable 564 the list of synonym phrases to be edited by a user. For example, a user (e.g., user 36, 38, 40, 42) may be enabled 564 to edit the list of synonym phrases (for not happy) by e.g., adding phrases to the list or removing phrases from the list. For example, if the user is producing probabilistic model 100 for use by a Michelin-starred restaurant, the user may wish to edit the list of synonym phrases (for not happy) to e.g., remove f'ed up and to add somewhat underwhelmed.

For example and when enabling 564 the list of synonym phrases (for not happy) to be edited by a user (e.g., user 36, 38, 40, 42), probabilistic modeling process 10 may provide 566 the list of synonym phrases (for not happy) to the user (e.g., user 36, 38, 40, 42). For example, probabilistic modelling process 10 may render the list of synonym phrases (for not happy) on a display screen of a client electronic device utilized by the user. Further and when enabling 564 the list of synonym phrases (for not happy) to be edited by a user (e.g., user 36, 38, 40, 42), probabilistic modeling process 10 may receive 568 one or more edits from the user (e.g., user 36, 38, 40, 42) concerning the list of synonym phrases (for not happy) and may revise 570 the list of synonym phrases (for not happy) based, at least in part, upon the one or more edits received from the user (e.g., user 36, 38, 40, 42). For example, probabilistic modelling process 10 may receive 568 edits provided by the user (e.g., user 36, 38, 40, 42) via the client electronic device utilized by the user (e.g., user 36, 38, 40, 42), wherein these edits may be used to revise 570 the list of synonym phrases (for not happy).

### Importing Known Taxonomy:

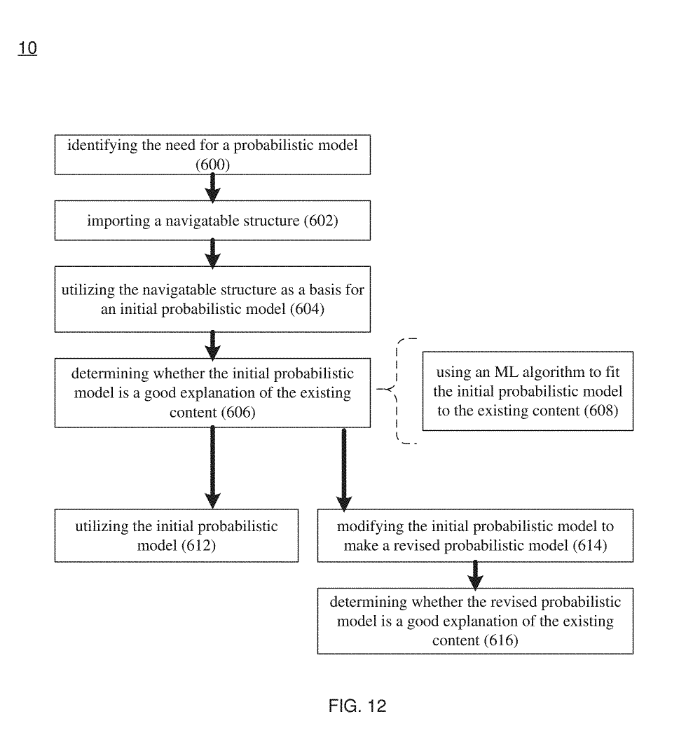

Referring also to FIG. 12 and as will be discussed below in greater detail, probabilistic modeling process 10 may be configured to “jump start” the generation of a probabilistic model by importing an existing navigatable structure.

As discussed above, probabilistic model 100 may be utilized to categorize content 56, thus allowing the various messages included within content 56 to be routed to (in the above-described example) one of eight nodes (e.g., good service node 126, bad service node 130, good meal node 140, bad meal node 144, good location node 154, bad location node 158, good value node 168, and bad value node 172).

However and as described above, the user of probabilistic modeling process 10 may read a portion of the messages included within content 56 and may determine that the portion of messages reviewed all seem to concern either a) the service, b) the meal, c) the location and/or d) the value of restaurant 58. Accordingly, probabilistic modeling process 10 may be configured to allow the user to define one or more probabilistic model variables, which (in this example) may include one or more probabilistic model branch variables. Examples of such probabilistic model branch variables may include but are not limited to one or more of: a) a weighting on branches off of a branching node; b) a weighting on values of a variable in the model; c) a minimum acceptable quantity of branches off of the branching node (e.g., branching node 102); d) a maximum acceptable quantity of branches off of the branching node (e.g., branching node 102); and e) a defined quantity of branches off of the branching node (e.g., branching node 102).

Accordingly and in the example discussed above, probabilistic modeling process 10 may require and may utilize user-defined variables to define the initial structure of probabilistic model 100. However, and as will be discussed below in greater detail, probabilistic modeling process 10 may be configured to “jump start” the generation of probabilistic model 100 by importing an existing navigatable structure.

Accordingly, probabilistic modeling process 10 may identify 600 the need for a probabilistic model (e.g., probabilistic model 100) to process existing content (e.g., content 56). In order to expedite the generation of probabilistic model 100 and to reduce the amount that a user is required to define the initial structure of probabilistic model 100, probabilistic modeling process 10 may import 602 a navigatable structure (e.g., navigatable structure 72) and may utilize 604 the navigatable structure (e.g., navigatable structure 72) as a basis for an initial probabilistic model (i.e., the initial version or starting point of probabilistic model 100).

As discussed above, probabilistic model 100 is formatted in a hierarchical manner to allow content (e.g., messages within content 56) may be routed to/flow through various nodes. Accordingly, any navigatable structure that is capable of routing content and/or providing insight into the manner in which content should be processed may serve as a basis for an initial probabilistic model (i.e., the initial version or starting point of probabilistic model 100). Therefore, examples of navigatable structure 72 may include but are not limited to: an interactive voice response (IVR) tree; a file directory structure; an analysis flowchart; and a data organizational structure, as any of these structures may be capable of routing content and/or providing insight into the manner in which content should be processed. For example, an interactive voice response (IVR) tree may define the manner in which telephone calls are routed within a call center. A file directory structure may define the manner in which content is organized. An analysis flowchart may define the manner in which issues are analyzed. And a data organization structure may define the manner in which an entity is organized.

Assume for illustrative purposes that upon importing 602 navigatable structure 72, probabilistic modeling process 10 may utilize 604 navigatable structure 72 as a basis for an initial probabilistic model (e.g., probabilistic model 100). Probabilistic modeling process 10 may then determine 606 whether the initial probabilistic model (e.g., probabilistic model 100) is a good explanation of the existing content (e.g., content 56).

When determining 606 whether the initial probabilistic model (e.g., probabilistic model 100) is a good explanation of the existing content (e.g., content 56), probabilistic modeling process 10 may use 608 an ML algorithm to fit the initial probabilistic model (e.g., probabilistic model 100) to the existing content (e.g., content 56), wherein examples of such an ML algorithm may include but are not limited to one or more of: an inferencing algorithm, a learning algorithm, an optimization algorithm, and a statistical algorithm.

For example and as discussed above, probabilistic modeling process 10 may generate new content (e.g., new content 56′) via the initial probabilistic model (i.e., probabilistic model 100 that is currently based on navigatable structure 72). Probabilistic modeling process 10 may then compare the new content (e.g., new content 56′) to the existing content (e.g., content 56) to determine whether the initial probabilistic model (i.e., probabilistic model 100 that is currently based on navigatable structure 72) is a good explanation of content 56.

If the initial probabilistic model (i.e., probabilistic model 100 that is currently based on navigatable structure 72) is a good explanation of the existing content (e.g., content 56), probabilistic modeling process 10 may utilize 612 the initial probabilistic model (i.e., probabilistic model 100 that is currently based on navigatable structure 72).

Conversely, if the initial probabilistic model (i.e., probabilistic model 100 that is currently based on navigatable structure 72) is not a good explanation of the existing content (e.g., content 56), probabilistic modeling process 10 may modify 614 the initial probabilistic model (i.e., probabilistic model 100 that is currently based on navigatable structure 72) to make a revised probabilistic model (e.g., revised probabilistic model 100′). Probabilistic modeling process 10 may then determine 616 whether the revised probabilistic model (e.g., revised probabilistic model 100′) is a good explanation of the existing content (e.g., content 56).

### Bayesian Questions:

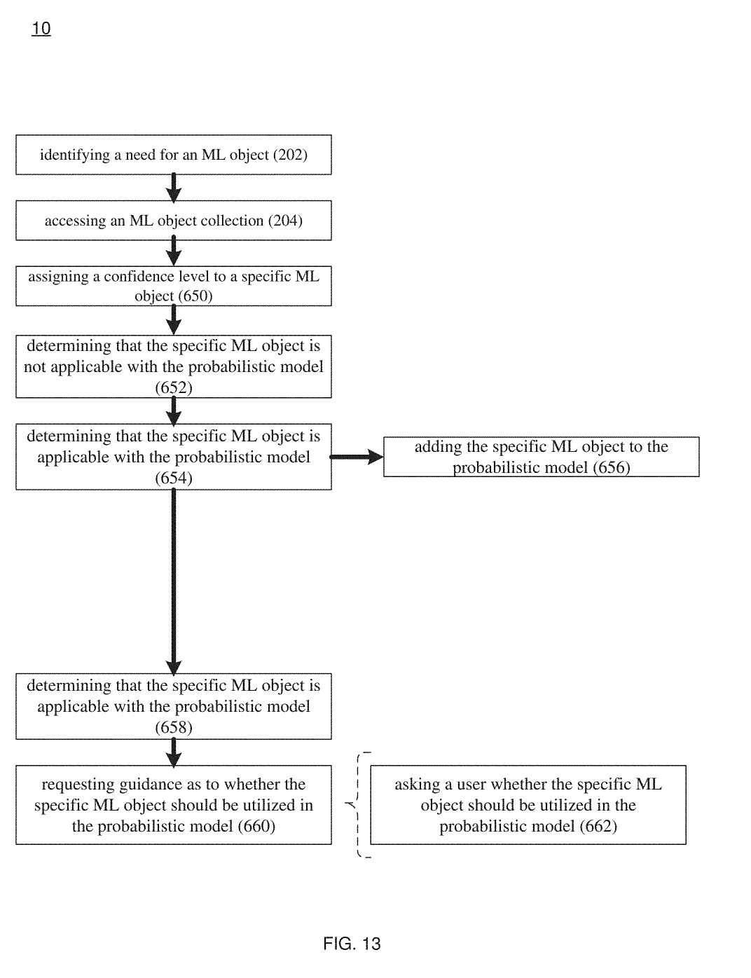

Referring also to FIG. 13 and as will be discussed below in greater detail, probabilistic modeling process 10 may be configured to allow the usage of one or more of plurality of ML objects 64 defined within ML object collection 62 to be partially automated by seeking user advice concerning the same.

As discussed above, probabilistic modeling process 10 may identify 202 a need for an ML object within a probabilistic model (e.g., probabilistic model 100). Specifically and as discussed above, assume that after probabilistic modeling process 10 defines the four branches off of branching node 102 (e.g., service branch 104, meal branch 106, location branch 108, and value branch 110), probabilistic modeling process 10 identifies 202 the need for an ML object within probabilistic model 100 that may process service-based content (i.e., effectuate the functionality of portion 176 of probabilistic model 100 that is configured to process the service-based content within content 56).

Further and as discussed above, probabilistic modeling process 10 may access 204 an ML object collection (e.g., ML object collection 62) that defines plurality of ML objects 64 and may identify a specific ML object (e.g., ML object 66) chosen from plurality of ML objects 64 defined within the ML object collection (e.g., ML object collection 62). Assume that upon accessing 204 ML object collection 62, probabilistic modeling process 10 may identify ML object 66 as an ML object that may (potentially) process the service-based content within content 56.

Once identified, probabilistic modeling process 10 may assign 650 a confidence level to a specific ML object (e.g., ML object 66), chosen from plurality of ML objects 64, concerning the applicability of the specific ML object (e.g., ML object 66) with the probabilistic model (e.g., probabilistic model 100).

As discussed above, probabilistic modeling process 10 may determine whether a specific ML object (e.g., ML object 66) is applicable with probabilistic model 100 by performing the above-described comparisons. Further and as discussed above, probabilistic modeling process 10 may use an ML algorithm to fit probabilistic model 100 to the content, wherein examples of such an ML algorithm may include but are not limited to one or more of: an inferencing algorithm, a learning algorithm, an optimization algorithm, and a statistical algorithm

Accordingly and when determining whether the specific ML object (e.g., ML object 66) is applicable with probabilistic model 100, probabilistic modeling process 10 may generate a very large quantity of messages e.g., by auto-generating messages using probabilistic model 100 (with ML object 66 installed), thus resulting in generated content 56′. Probabilistic modeling process 10 may then compare generated content 56′ to content 56 to determine if probabilistic model 100 (with ML object 66 installed) is a good explanation of content 56. And if probabilistic model 100 (with ML object 66 installed) is a good explanation of content 56, probabilistic modeling process 10 may determine that the specific ML object (e.g., ML object 66) is applicable with the probabilistic model (e.g., probabilistic model 100). This comparison (between generated content 56′ and content 56) may be considered, in whole or in part, when assigning 650 a confidence level to a specific ML object (e.g., ML object 66).

For example and when comparing generated content 56′ to content 56:
a low level of similarity between generated content 56′ and content 56 may result in probabilistic modeling process 10 assigning a low confidence level to the specific ML object (e.g., ML object 66).
an intermediate level of similarity between generated content 56′ and content 56 may result in probabilistic modeling process 10 assigning an intermediate confidence level to the specific ML object (e.g., ML object 66).
a high level of similarity between generated content 56′ and content 56 may result in probabilistic modeling process 10 assigning a high confidence level to the specific ML object (e.g., ML object 66).

Accordingly, probabilistic modeling process 10 may determine 652 that the specific ML object (e.g., ML object 66) is not applicable with the probabilistic model (e.g., probabilistic model 100 with ML object 66 installed) when the confidence level assigned is in a low confidence level range.

If it is determined 652 that the confidence level assigned is in the low confidence level range, probabilistic modeling process 10 may remove the specific ML object (e.g., ML object 66) from probabilistic model 100 and an alternative ML object may be sought.

Conversely, probabilistic modeling process 10 may determine 654 that the specific ML object (e.g., ML object 66) is applicable with the probabilistic model (e.g., probabilistic model 100 with ML object 66 installed) when the confidence level assigned is in a high confidence level range.

If it is determined 654 that the confidence level assigned is in the high confidence level range, probabilistic modeling process 10 may add 656 the specific ML object (e.g., ML object 66) to the probabilistic model (e.g., probabilistic model 100).

Further still, probabilistic modeling process 10 may determine 658 that the specific ML object (e.g., ML object 66) is possibly applicable with the probabilistic model (e.g., probabilistic model 100 with ML object 66 installed) when the confidence level assigned is in an intermediate confidence level range.

If it is determined 658 that the confidence level assigned is in the intermediate confidence level range, probabilistic modeling process 10 may request 660 guidance as to whether the specific ML object (e.g., ML object 66) should be utilized in the probabilistic model (e.g., probabilistic model 100).

When requesting 660 guidance as to whether the specific ML object (e.g., ML object 66) should be utilized in the probabilistic model (e.g., probabilistic model 100), probabilistic modeling process 10 may ask 662 a user (e.g., user 36) whether the specific ML object (e.g., ML object 66) should be utilized in the probabilistic model (e.g., probabilistic model 100). For example, probabilistic modeling process 10 may e.g., render a message on a display screen of client electronic devices 28 associated with user 36 to inquire as to whether e.g., user 36 is interested in using ML object 66.

### BO 2-3 & Prediction:

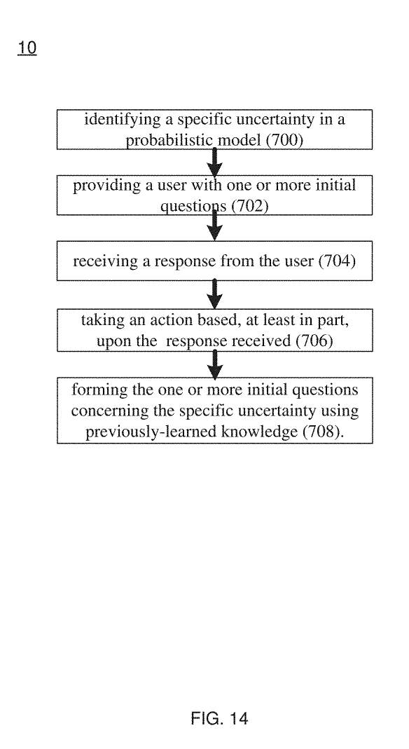

Referring also to FIG. 14 and as will be discussed below in greater detail, probabilistic modeling process 10 may be configured to interact with a user to clarify specific uncertainties with respect to a probabilistic model (e.g., probabilistic model 100).

As discussed above, probabilistic model 100 may be used to e.g., process pictures of animals to determine if the animal in the picture is a dog or a cat. Continuing with such an example, assume that the content (e.g., content 56) is a large quantity of pictures of animals and probabilistic model 100 is processing content 56 to determine which (if any) of the pictures include within content 56 are pictures of dogs or pictures of cats. Further, assume that as probabilistic model 10 processes content 56, the pictures within content 56 are categorized as pictures of dogs, pictures of cats, or pictures of other animals (i.e., not dogs or cats).

Assume that when processing content 56, as long as probabilistic model 100 has a certain confidence level (as discussed above), probabilistic model 100 may process content 56 without needing any input/guidance from e.g., a user of probabilistic model 100. However, in the event that the confidence level assigned/defined by probabilistic model 100 with respect to e.g., a particular picture being a picture of a dog, a picture of a cat or a picture of some other type of animal falls below an acceptable level (e.g., 95%), probabilistic model 100 may request guidance from a user (e.g., user 36).

For example, assume that a particular picture (e.g., picture 74) within content 56 is a picture of a cat. However, assume for this example, that this particular cat looks somewhat “dog-like” and resulted in probabilistic model 100 being uncertain concerning whether this picture (e.g., picture 74) is a picture of a cat. Accordingly, probabilistic modeling process 10 may identify 700 a specific uncertainty in a probabilistic model (e.g., probabilistic model 100). In this particular example, this “specific uncertainty” is whether picture 74 is a picture of a cat. As discussed above, probabilistic model 100 may deem this to be a “specific uncertainty” if e.g., the confidence level assigned/defined to picture 74 being a picture of a cat is below 95%.

When probabilistic model 10 identifies 700 such a specific uncertainty, probabilistic modeling process 10 may provide 702 a user (e.g., user 36) with one or more initial questions concerning the specific uncertainty (e.g., whether picture 74 is a picture of a cat). When providing 702 the above-described inquiry, probabilistic modeling process 10 may e.g., render a message on a display screen of client electronic devices 28 associated with user 36 to provide the one or more initial questions concerning the specific uncertainty (e.g., whether picture 74 is a picture of a cat). Alternative and in a configuration in which probabilistic modeling process 10 is interacting with user 36 verbally, the inquiry may be made verbally. Continuing with the above-stated example and with respect to picture 74, probabilistic modeling process 10 may provide 702 user 36 with the question: “Is this a picture of a cat?”.

Probabilistic modeling process 10 may receive 704 a response (e.g., response 76) from the user (e.g., user 36) concerning the one or more initial questions (e.g., “Is this a picture of a cat?”) with respect to the specific uncertainty. The response provided by the user (e.g., user 36) may provide varying levels of information to probabilistic model 100.

For example, the response (e.g., response 76) received from the user (e.g., user 36) with respect to the specific uncertainty may define a value for the specific uncertainty. As discussed above and in this particular example, this “specific uncertainty” is whether picture 74 is a picture of a cat. Accordingly and when the response (e.g., response 76) received from the user (e.g., user 36) with respect to the specific uncertainty defines a value for the specific uncertainty, response 76 may be “Yes, that is a cat”. Accordingly and in such a situation, the specific uncertainty (e.g., whether picture 74 is a picture of a cat) is resolved by response 76 (namely, “yes, that is a cat”).

Alternatively, the response (e.g., response 76) received from the user (e.g., user 36) with respect to the specific uncertainty may reduce the uncertainty level of the specific uncertainty. As discussed above and in this particular example, this “specific uncertainty” is whether picture 74 is a picture of a cat. Accordingly and when the response (e.g., response 76) received from the user (e.g., user 36) with respect to the specific uncertainty reduces the uncertainty level of the specific uncertainty, response 76 may be “I am not sure but it looks like a cat”. Accordingly and in such a situation, the specific uncertainty (e.g., whether picture 74 is a picture of a cat) is not resolved by one portion of response 76 (namely, “I am not sure . . . ”). However, the uncertainty level of the specific uncertainty is reduced by another portion of response 76 (namely “ . . . but it looks like a cat”).

Additionally, the response (e.g., response 76) received from the user (e.g., user 36) with respect to the specific uncertainty may include rule-based information that may be used with a future uncertainty. As discussed above and in this particular example, this “specific uncertainty” is whether picture 74 is a picture of a cat. Accordingly and when the response (e.g., response 76) received from the user (e.g., user 36) with respect to the specific uncertainty includes rule-based information that may be used with a future uncertainty, response 76 may be “it is a cat because it has a short snout”. Accordingly and in such a situation, the specific uncertainty (e.g., whether picture 74 is a picture of a cat) is resolved by one portion of response 76 (namely, “it is a cat . . . ”). Further, another portion of response 76 (namely “ . . . because it has a short snout”) provides rule-based information that may be used with a future uncertainty. Accordingly, in the event that there is a future uncertainty concerning whether a certain picture is a picture of a cat, if the animal in the picture has a short snort, that may be taken into consideration when probabilistic modeling process 10 assigns/defines a confidence level with respect to that certain picture (i.e., wherein the increase in confidence level associated with the animal having a short snout may be enough to raise the confidence level into the range that does not require user intervention).

Once response 76 is received 704, probabilistic modeling process 10 may take 706 an action based, at least in part, upon the response (e.g., response 76) received 704 from the user (e.g., user 36). Examples of such an action taken 706 may include but are not limited to: clarifying the specific uncertainty (e.g., whether picture 74 is a picture of a cat) and providing the user (.e., user 36) with one or more additional questions concerning the specific uncertainty (e.g., whether picture 74 is a picture of a cat).

For example, if response 76 (namely, “yes, that is a cat”) resolves the specific uncertainty (e.g., whether picture 74 is a picture of a cat), the action taken 706 by probabilistic modeling process 10 may include clarifying the specific uncertainty by defining picture 74 as a picture of a cat. However, if response 76 (namely, “I am not sure but it looks like a cat”) does not resolve the specific uncertainty (e.g., whether picture 74 is a picture of a cat), the action taken 706 by probabilistic modeling process 10 may include providing the user (.e., user 36) with one or more additional questions (e.g., “Why does it look like a cat?”).

As discussed above, the response (e.g., response 76) received from the user (e.g., user 36) with respect to the specific uncertainty may include rule-based information that may be used with a future uncertainty, wherein an example of such rule-based information may be cats have short snouts. Accordingly, probabilistic modeling process 10 may form 708 the one or more initial questions concerning the specific uncertainty (e.g., whether a picture is a picture of a cat) using previously-learned knowledge. For example, assume that probabilistic modeling process 10 is unsure concerning another picture (e.g., picture 78), wherein probabilistic modeling process does not know whether the animal in picture 78 is a cat. However, the animal is picture 78 has a short snout. As discussed above, probabilistic modeling process 10 learned that cats have short snouts due to response 76 received from user 36. Accordingly and when forming 708 the initial questions concerning picture 78, probabilistic modeling process 10 may take this ruled-based information into consideration and may provide user 36 with the question: “This is a cat right?”

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
identifying a specific uncertainty in a probabilistic model;
providing a user with one or more initial questions concerning the specific uncertainty; and
receiving a response from the user concerning the one or more initial questions.

2. The computer-implemented method of claim 1 wherein the response received from the user defines a value for the specific uncertainty.

3. The computer-implemented method of claim 1 wherein the response received from the user reduces the uncertainty level of the specific uncertainty.

4. The computer-implemented method of claim 1 wherein the response received from the user includes rule-based information that may be used with a future uncertainty.

5. The computer-implemented method of claim 1 further comprising:
taking an action based, at least in part, upon the response received from the user.

6. The computer-implemented method of claim 5 wherein the action taken includes clarifying the specific uncertainty.

7. The computer-implemented method of claim 5 wherein the action taken includes providing the user with one or more additional questions concerning the specific uncertainty.

8. The computer-implemented method of claim 1 further comprising:
forming the one or more initial questions concerning the specific uncertainty using previously-learned knowledge.

9. A computer program product residing on a computer readable medium having a plurality of instructions stored thereon which, when executed by a processor, cause the processor to perform operations comprising:
identifying a specific uncertainty in a probabilistic model;
providing a user with one or more initial questions concerning the specific uncertainty; and
receiving a response from the user concerning the one or more initial questions.

10. The computer program product of claim 9 wherein the response received from the user defines a value for the specific uncertainty.

11. The computer program product of claim 9 wherein the response received from the user reduces the uncertainty level of the specific uncertainty.

12. The computer program product of claim 9 wherein the response received from the user includes rule-based information that may be used with a future uncertainty.

13. The computer program product of claim 9 further comprising:
taking an action based, at least in part, upon the response received from the user.

14. The computer program product of claim 13 wherein the action taken includes clarifying the specific uncertainty.

15. The computer program product of claim 13 wherein the action taken includes providing the user with one or more additional questions concerning the specific uncertainty.

16. The computer program product of claim 9 further comprising:
forming the one or more initial questions concerning the specific uncertainty using previously-learned knowledge.

17. A computing system including a processor and memory configured to perform operations comprising:
identifying a specific uncertainty in a probabilistic model;
providing a user with one or more initial questions concerning the specific uncertainty; and
receiving a response from the user concerning the one or more initial questions.

18. The computing system of claim 17 wherein the response received from the user defines a value for the specific uncertainty.

19. The computing system of claim 17 wherein the response received from the user reduces the uncertainty level of the specific uncertainty.

20. The computing system of claim 17 wherein the response received from the user includes rule-based information that may be used with a future uncertainty.

21. The computing system of claim 17 further comprising:
taking an action based, at least in part, upon the response received from the user.

22. The computing system of claim 21 wherein the action taken includes clarifying the specific uncertainty.

23. The computing system of claim 21 wherein the action taken includes providing the user with one or more additional questions concerning the specific uncertainty.

24. The computing system of claim 17 further comprising:
forming the one or more initial questions concerning the specific uncertainty using previously-learned knowledge.
